(19) United States
(12) Patent Application Publication
(10) Pub. No.: US 2015/0206169 A1
(43) Pub. Date: Jul. 23, 2015

(54) SYSTEMS AND METHODS FOR EXTRACTING AND GENERATING IMAGES FOR DISPLAY CONTENT

(71) Applicant: Google Inc., Mountain View, CA (US)

(72) Inventors: Kai Ye, Santa Clara, CA (US); Guannan Zhang, Shanghai (CN)

(73) Assignee: Google Inc., Mountain View, CA (US)

(21) Appl. No.: 14/157,955

(22) Filed: Jan. 17, 2014

(51) Int. Cl. G06Q 30/02

(52) U.S. Cl. CPC G06Q 30/0242

(57) ABSTRACT

Systems and methods for automatically generating display content are provided. A uniform resource locator identifying a landing resource is received from a third-party content provider. One or more images are extracted from the landing resource. The extracted images are analyzed to detect the visual content and semantic content thereof. The extracted images are scored based on at least one of the detected visual content and the detected semantic content. The highest-scoring image is selected from a set of images that includes the images extracted from the landing resource. A third-party content item that includes the selected image is generated and served to a user device. The third-party content item is configured to direct the user device to the landing resource.

### CROSS-REFERENCE TO RELATED PATENT APPLICATIONS

This application is a continuation which claims the benefit of and priority to International Application No. PCT/CN2013/086779, filed Nov. 8, 2013. The entire disclosure of International Application No. PCT/CN2013/086779 is incorporated herein by reference.

### BACKGROUND

In a computerized content delivery network, third-party content providers typically design and provide display content (e.g., display advertisements) for delivery to a user device via one or more content slots of an electronic resource. Display content can include, for example, images, video, graphics, text, and/or other visual imagery. It can be difficult and challenging for third-party content providers to create effective and attractive display content.

Various templates and stock elements have been used to partially automate the process of creating display content. However, display content created from rigid templates and stock elements are often stale, unattractive, and not well-suited to the particular business, product, or service featured in the display content.

### SUMMARY

One implementation of the present disclosure is a computerized method for automatically generating display content. The method is performed by a processing circuit. The method includes receiving, at the processing circuit, a uniform resource locator from a third-party content provider. The uniform resource locator identifies a landing resource. The method further includes extracting an image from the landing resource, analyzing the extracted image to detect visual content of the image and semantic content of the image, scoring the image based on at least one of the detected visual content and the detected semantic content, selecting a highest-scoring image from a set of images comprising the image extracted from the landing resource, and generating a third-party content item that includes the selected image. The third-party content item is configured to direct to the landing resource.

In some implementations, the method further includes determining whether processing is required for the image based on a result of the analysis and processing the image to enhance at least one of the detected visual content of the image and the detected semantic content of the image in response to a determination that processing is required.

In some implementations, extracting the image from the landing resource includes determining a salience score for the image. The salience score indicates a prominence with which the extracted image is displayed on the landing resource.

In some implementations, the method further includes collecting a plurality of images from multiple different locations including at least one of the landing resource, a resource under a same domain or sub-domain as the landing resource, and a repository of images previously used in content items associated with the third-party content provider.

In some implementations, analyzing the extracted image to detect visual content includes determining a position of a salient object in the image. In some implementations, determining a position of a salient object in the image includes at least one of detecting a color distribution of the image and detecting an edge of the salient object in the image. In some implementations, analyzing the extracted image to detect visual content includes determining a position of text in the image. In some implementations, analyzing the extracted image to detect visual content includes generating a salience map for the image. The salience map identifies a position of a salient object in the image and a position of any text in the image.

In some implementations, analyzing the extracted image to detect semantic content includes generating one or more labels describing the semantic content of the image and storing the generated labels as attributes of the image.

In some implementations, analyzing the extracted image to detect visual content includes determining whether to crop the image based on a location of a salient object represented in the image. In some implementations, processing the image includes cropping the image to enhance a visual impact of the salient object in response to a determination to crop the image.

In some implementations, the method further includes identifying one or more aesthetic features of the image and applying the one or more aesthetic features as inputs to an algorithmic ranking process trained on human-labeled image preferences. The algorithmic ranking process is configured to use the aesthetic features to generate a quality score for the image based on the human-labeled image preferences.

Another implementation of the present disclosure is a system for automatically generating display content. The system includes a processing circuit configured to receive a uniform resource locator from a third-party content provider. The uniform resource locator identifies a landing resource. The processing circuit is further configured to extract an image from the landing resource, analyze the extracted image to detect visual content of the image and semantic content of the image, score the image based on at least one of the detected visual content and the detected semantic content, select a highest-scoring image from a set of images that includes the image extracted from the landing resource, and generate a third-party content item that includes the selected image. The third-party content item is configured to direct to the landing resource.

In some implementations, the processing circuit is configured to determine whether processing is required for the image based on a result of the analysis and process the image to enhance at least one of the detected visual content of the image and the detected semantic content of the image in response to a determination that processing is required.

In some implementations, extracting the image from the landing resource includes determining a salience score for the image. The salience score indicates a prominence with which the extracted image is displayed on the landing resource.

In some implementations, the processing circuit is configured to collect a plurality of images from multiple different locations including at least one of the landing resource, a resource under a same domain or sub-domain as the landing resource, and a repository of images previously used in content items associated with the third-party content provider.

In some implementations, analyzing the extracted image to detect visual content includes determining a position of at least one of a salient object in the image and text in the image. In some implementations, analyzing the extracted image to detect visual content includes generating a salience map for the image. The salience map identifies the position of at least one of the salient object in the image and the text in the image.

In some implementations, analyzing the extracted image to detect semantic content includes generating one or more labels describing the semantic content of the image and storing the generated labels as attributes of the image.

In some implementations, analyzing the extracted image to detect visual content includes determining whether to crop the image based on a location of a salient object represented in the image. In some implementations, processing the image includes cropping the image to enhance a visual impact of the salient object in response to a determination to crop the image.

Another implementation of the present disclosure is a system for extracting and generating images for display content. The system includes a processing circuit configured to extract images from a plurality of data sources including a landing resource and at least one other data source. The processing circuit is further configured to detect a distribution of content in each of the extracted images. The distribution of content includes at least one of a location of a salient object and a location of text. The processing circuit is further configured to process the extracted images based on a result of the content distribution detection. Processing an extracted image includes cropping the extracted image in response to a determination that the salient object detected in the image occupies less than a threshold area in the image. The processing circuit is further configured to rank the extracted images based at least partially on a result of the content distribution detection.

In some implementations, the processing circuit is configured to calculate an on-page salience score for each of the images extracted from the landing resource. The salience score indicates a prominence with which the extracted image is displayed on the landing resource. In some implementations, ranking the extracted images is based at least partially on the on-page salience scores for each of the images extracted from the landing resource.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a block diagram of a computer system including a network, content requestors, landing resources, a resource renderer, and a content generation system, according to a described implementation.

FIG. 2 is a block diagram illustrating the content generation system of FIG. 1 in greater detail, showing an image module, a color module, a text module, a font module, and a layout module, according to a described implementation.

FIG. 3 is a block diagram illustrating the image module of FIG. 2 in greater detail, showing an image extraction module, a content detection module, an image processing module, and an image ranking module, according to a described implementation.

FIG. 4 is a block diagram illustrating the color module of FIG. 2 in greater detail, showing a color extractor and a color scheme selector, according to a described implementation.

FIG. 5 is a block diagram illustrating the text module of FIG. 2 in greater detail, showing a review locator, a sentiment detector, and a text selector, according to a described implementation.

FIG. 6 is a block diagram illustrating the layout module of FIG. 2 in greater detail, showing a layout generator and a layout scorer, according to a described implementation.

FIG. 7 is a drawing of a “half-and-half” layout which may be generated by the layout generator of FIG. 6, according to a described implementation.

FIG. 8 is a drawing of a “text overlay” layout which may be generated by the layout generator of FIG. 6, according to a described implementation.

FIG. 9 is a drawing of a “slanted text” layout which may be generated by the layout generator of FIG. 6, according to a described implementation.

FIG. 10 is a drawing of a “blurred image” layout which may be generated by the layout generator of FIG. 6, according to a described implementation.

FIG. 11A is a drawing of a flexible layout which may be generated by the layout generator of FIG. 6, showing a high scoring image and unused space, according to a described implementation.

FIG. 11B is a drawing of the flexible layout shown in FIG. 11A with the unused space divided into several rectangles, according to a described implementation.

FIG. 11C is a drawing of the flexible layout shown in FIG. 11B after combining some of the rectangles into a larger “landscape-style” rectangle, according to a described implementation.

FIG. 11D is a drawing of the flexible layout shown in FIG. 11B after combining some of the rectangles into a larger “portrait-style” rectangle, according to a described implementation.

FIG. 12A is a drawing of a flexible layout which may be generated by the layout generator of FIG. 6 as applied to a “banner-style” content item including an image, headline text, and unused space, according to a described implementation.

FIG. 12B is a drawing of the flexible layout as applied to the “banner-style” content item shown in FIG. 12A with the unused space divided into several rectangles, according to a described implementation.

FIG. 13 is a flowchart of a process for automatically generating display content, according to a described implementation.

FIG. 14 is a flowchart of a process for automatically generating a textual portion of a display content item or a purely textual content item, according to a described implementation.

FIG. 15 is a flowchart of a process for generating unique-looking layouts for content items based on the images, text, colors, and fonts extracted from a landing resource, according to a described implementation.

FIG. 16 is a flowchart of a process for extracting and generating images for display content, according to a described implementation.

### DETAILED DESCRIPTION

Referring generally to the FIGURES, systems and methods for extracting and generating images for display content are shown, according to a described implementation. The system and methods described herein may be used to automatically generate third-party content items that are tailored to a particular third-party content provider and/or a particular landing resource. Images and other visual information (e.g., colors, text, graphics, fonts, styles, etc.) are extracted from the landing resource and used to generate third-party content items associated with the landing resource. For example, the images and other visual information can be used to generate third-party content items that direct to the landing resource (e.g., via an embedded hyperlink) upon a user interaction with the third-party content item (e.g., clicking the content item, hovering over the content item, etc.).

In operation, a content generation system in accordance with the present disclosure receives a uniform resource locator (URL) from a third-party content provider. The URL identifies a particular electronic resource (e.g., a webpage) referred to here as the landing resource. Third-party content providers may submit the URL to the content generation system as part of a request to generate third-party content items (e.g., display advertisements) that direct to the landing resource. The content generation system uses the URL to navigate to the landing resource and to extract images and other visual information therefrom.

In some implementations, the content generation system analyzes the images extracted from the landing resource to detect the visual content of the images. Detecting visual content may include, for example, determining a location of a salient object represented in the image, determining a location of text in the image, and/or determining whether the image can be cropped or processed to improve the visual impact of the image. In some implementations, the content generation system analyzes the images extracted from the landing resource to detect the semantic content of the images. Detecting semantic content may include, for example, identifying an object depicted in the image or a meaning conveyed by the image. Labels or keywords describing the semantic content of the image can be associated with the image used to determine a relevancy of the image to a particular third-party content item.

In some implementations, the content generation system processes the images. Image processing may include cropping the images to emphasize salient objects or to remove text, resizing the images, formatting the images, or otherwise preparing the images for inclusion in a third-party content item. In some implementations, image processing includes enhancing a logo image.

The content generation system may filter and rank images based on various attributes of the images. For example, images having a display size less than a threshold display size or a quality score less than a threshold quality score may be filtered. Images can be ranked based on a salience score associated with each of the images. The salience score may indicate a prominence with which the extracted image is displayed on the landing resource. The content generation system may select the top ranking image or images for inclusion in a display content item.

In some implementations, the content items created by the content generation system are advertisements. The advertisements may be display advertisements such as image advertisements, flash advertisements, video advertisements, text-based advertisements, or any combination thereof. In other implementations, the content generation system may be used to generate other types of content (e.g., text content, display content, etc.) which serve various non-advertising purposes.

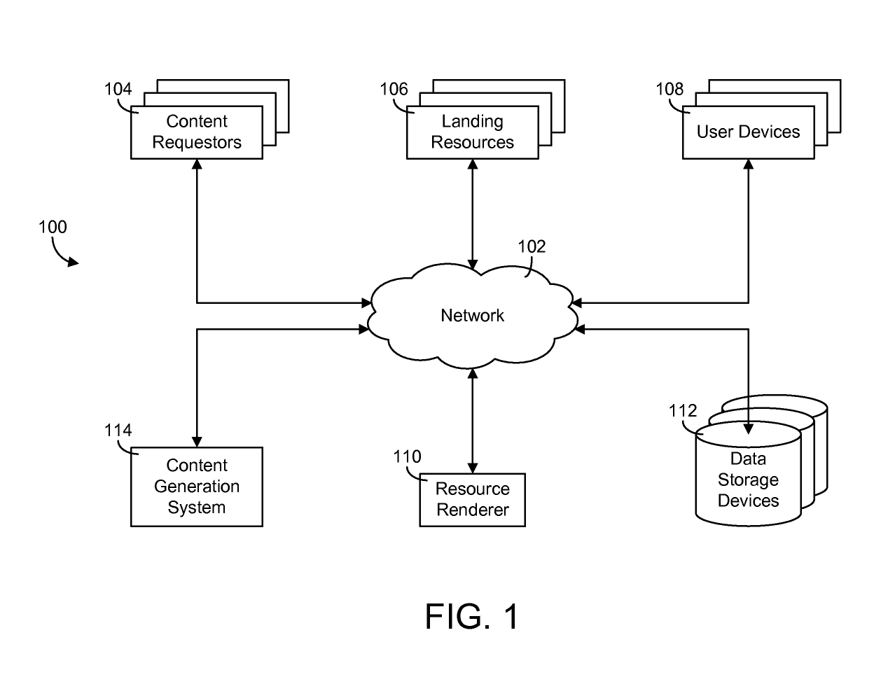

Referring now to FIG. 1, a block diagram of a computer system 100 is shown, according to a described implementation. Computer system 100 is shown to include a network 102, content requestors 104, landing resources 106, user devices 108, a resource renderer 110, data storage devices 112, and a content generation system 114. Computer system 100 may facilitate communications between content generation system 114 and content requestors 104. For example, content generation system 114 may receive a content generation request from content requestors 104 via network 102. Content generation system 114 may create content items in response to the request and provide the generated content items to content requestors 104 for review or approval.

Computer system 100 may also facilitate communications between content generation system 114, landing resources 106, and resource renderer 110. For example, content generation system 114 may receive visual information from landing resources 106 and/or resource renderer 110. For example, upon receiving a request for content generation, content generation system 114 may invoke resource renderer 110 to obtain (e.g., download) and render data from landing resources 106. Resource renderer 110 may receive data from landing resources 106 via network 102 and render such data as a snapshot image (e.g., a visual representation of landing resources 106) and/or as a document object model (DOM) tree. The rendered data may be transmitted from resource renderer 110 to content generation system 114 via network 102.

Network 102 may include any type of computer network such as local area networks (LAN), wide area networks (WAN), cellular networks, satellite networks, radio networks, the Internet, or any other type of data network. Network 102 may include any number of computing devices (e.g., computers, servers, routers, network switches, etc.) configured to transmit, receive, or relay data. Network 102 may further include any number of hardwired and/or wireless connections. For example, content requestor 104 may communicate wirelessly (e.g., via WiFi, cellular, radio, etc.) with a transceiver that is hardwired (e.g., via a fiber optic cable, a CAT5 cable, etc.) to a computing device of network 102.

Still referring to FIG. 1, computer system 100 is shown to include content requestors 104. Content requestors 104 may include one or more entities from which a request to generate content items is received. For example, content requestors 104 may include an advertiser, an advertising agency, a third-party content provider, a publisher, a website provider, or any other entity from which a request to generate content items can be received.

In some implementations, content requestors 104 include one or more electronic devices (e.g., a computer, a computer system, a server, etc.) capable of submitting a request for content generation. Content requestors 104 may include a user input device (e.g., keyboard, mouse, microphone, touch-screen, tablet, smart phone, etc.) through which a user may input content generation request. Content requestors 104 may submit a content generation request to content generation system 114 via network 102. In some implementations, the content generation request includes a uniform resource locator (URL). The URL may specify a location of a particular landing resource (e.g., one of landing resources 106).

In some implementations, content requestors 104 submit campaign parameters to content generation system 114. The campaign parameters may be used to control the distribution of third-party content items produced by content generation system 114. The campaign parameters may include keywords associated with the third-party content items, bids corresponding to the keywords, a content distribution budget, geographic limiters, or other criteria used by content generation system 114 or a separate content server to determine when a third-party content item may be presented to user devices.

Content requestors 104 may access content generation system 114 to monitor the performance of the third-party content items distributed according to the established campaign parameters. For example, content requestors 104 may access content generation system 114 to review one or more behavior metrics associated with a third-party content item or set of third-party content items. The behavior metrics may describe the interactions between user devices 108 with respect to a distributed third-party content item or set of third-party content items (e.g., number of impressions, number of clicks, number of conversions, an amount spent, etc.). The behavior metrics may be based on user actions logged and processed by an accounting system or a log file processing system.

Still referring to FIG. 1, computer system 100 is shown to include landing resources 106. Landing resources 106 may include any type of information or data structure that can be provided over network 102. In some implementations, landing resources 106 may be identified by a resource address associated with landing resource 106 (e.g., a URL). Landing resources 106 may include web pages (e.g., HTML web pages, PHP web pages, etc.), word processing documents, portable document format (PDF) documents, images, video, programming elements, interactive content, streaming video/audio sources, or other types of electronic information.

Landing resources 106 may be webpages, local resources, intranet resources, Internet resources, or other network resources. In some implementations, landing resources 106 include one or more webpages to which a user devices 108 are directed (e.g., via an embedded hyperlink) when user devices 108 interact with a content item generated by content generation system 114. In some implementations, landing resources 106 provide additional information relating to a product, service, or business featured in the generated content item. For example, landing resources 106 may be a website through which a product or service featured in the generated content item may be purchased.

In some implementations, landing resources 106 are specified by content requestor 104 as part of a request to generate content items. Landing resources 106 may be specified as a URL which directs to one of landing resources 106 or otherwise specifies the location of landing resources 106. The URL may be included as part of the content generation request. In some implementations, landing resources 106 may be combined with content requestors 104. For example, landing resources 106 may include data stored on the one or more electronic devices (e.g., computers, servers, etc.) maintained by content requestors 104. In other implementations, landing resources 106 may be separate from content requestors 104. For example, landing resources 106 may include data stored on a remote server (e.g., FTP servers, file sharing servers, web servers, etc.), combinations of servers (e.g., data centers, cloud computing platforms, etc.), or other data storage devices separate from content requestors 104.

Still referring to FIG. 1, computer system 100 is shown to include user devices 108. User devices 108 may include any number and/or type of user-operable electronic devices. For example, user devices 108 may include desktop computers, laptop computers, smartphones, tablets, mobile communication devices, remote workstations, client terminals, entertainment consoles, or any other devices capable of interacting with the other components of computer system 100 (e.g., via a communications interface). User devices 108 may be capable of receiving resource content from landing resources 106 and/or third-party content items generated by content generation system 114. User devices 108 may include mobile devices or non-mobile devices.

In some implementations, user devices 108 include an application (e.g., a web browser, a resource renderer, etc.) for converting electronic content into a user-comprehensible format (e.g., visual, aural, graphical, etc.). User devices 108 may include a user interface element (e.g., an electronic display, a speaker, a keyboard, a mouse, a microphone, a printer, etc.) for presenting content to a user, receiving user input, or facilitating user interaction with electronic content (e.g., clicking on a content item, hovering over a content item, etc.). User devices 108 may function as a user agent for allowing a user to view HTML encoded content.

User devices 108 may include a processor capable of processing embedded information (e.g., meta information embedded in hyperlinks, etc.) and executing embedded instructions. Embedded instructions may include computer-readable instructions (e.g., software code, JavaScript®, ECMAScript®, etc.) associated with a content slot within which a third-party content item is presented.

In some implementations, user devices 108 are capable of detecting an interaction with a distributed content item. An interaction with a content item may include displaying the content item, hovering over the content item, clicking on the content item, viewing source information for the content item, or any other type of interaction between user devices 108 and a content item. Interaction with a content item does not require explicit action by a user with respect to a particular content item. In some implementations, an impression (e.g., displaying or presenting the content item) may qualify as an interaction. The criteria for defining which user actions (e.g., active or passive) qualify as an interaction may be determined on an individual basis (e.g., for each content item) by content requestors 104 or by content generation system 114.

User devices 108 may generate a variety of user actions. For example, user devices 108 may generate a user action in response to a detected interaction with a content item. The user action may include a plurality of attributes including a content identifier (e.g., a content ID or signature element), a device identifier, a referring URL identifier, a timestamp, or any other attributes describing the interaction. User devices 108 may generate user actions when particular actions are performed by a user device (e.g., resource views, online purchases, search queries submitted, etc.). The user actions generated by user devices 108 may be communicated to content generation system 114 or a separate accounting system.

For situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated (e.g., by content generation system 114) in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, a user may have control over how information is collected (e.g., by an application, by user devices 108, etc.) and used by content generation system 114.

Still referring to FIG. 1, system 100 is shown to include a resource renderer 110. Resource renderer 110 may be a hardware or software component capable of interpreting landing resources 106 and creating a visual representation (e.g., an image, a display, etc.) thereof. For example, landing resources 106 may include marked up content (e.g., HTML, XML, image URLs, etc.) as well as formatting information (e.g., CSS, XSL, etc.). Resource renderer 110 may download the marked up content and formatting information and render landing resources 106 according to World Wide Web Consortium (W3C) standards. Resource renderer 110 may create a “snapshot image” of landing resources 106 and/or construct a document object model (DOM) tree representing landing resources 106.

The snapshot image may be a visual representation of a particular landing resource 106. The snapshot image may illustrate the visual appearance of the landing resource 106 as presented on a user interface device (e.g., an electronic display screen, a computer monitor, a touch-sensitive display, etc.) after rendering landing resource 106. The snapshot image may include color information (e.g., pixel color, brightness, saturation, etc.) and style information (e.g., square corners, rounded edges, modern, rustic, etc.) for landing resource 106. In some implementations, the snapshot image may be a picture file having any viable file extension (e.g. .jpg, .png, .bmp, etc.).

The DOM tree may be a hierarchical model of a particular landing resource 106. The DOM tree may include image information (e.g., image URLs, display positions, display sizes, alt text, etc.), font information (e.g., font names, sizes, effects, etc.), color information (e.g., RGB color values, hexadecimal color codes, etc.) and text information for the landing resource 106.

In various implementations, resource renderer 110 may be part of content generation system 114 or a separate component. Resource renderer 110 may prepare the snapshot image and/or DOM tree in response to a rendering request from content generation system 114. Resource renderer 110 may transmit the snapshot image and/or DOM tree to content generation system 114 in response to the rendering request.

Still referring to FIG. 1, computer system 100 is shown to include data storage devices 112. Data storage devices 112 may be any type of memory device capable of storing profile data, content item data, accounting data, or any other type of data used by content generation system 114 or another component of computer system 100. Data storage devices 112 may include any type of non-volatile memory, media, or memory devices. For example, data storage devices 112 may include semiconductor memory devices (e.g., EPROM, EEPROM, flash memory devices, etc.) magnetic disks (e.g., internal hard disks, removable disks, etc.), magneto-optical disks, and/or CD ROM and DVD-ROM disks.

In some implementations, data storage devices 112 are local to content generation system 114, landing resources 106, or content requestors 104. In other implementations, data storage devices 112 are remote data storage devices connected with content generation system 114 and/or content requestors 104 via network 102. In some implementations, data storage devices 112 are part of a data storage server or system capable of receiving and responding to queries from content generation system 114 and/or content requestors 104.

In some implementations, data storage devices 112 are configured to store visual information extracted from landing resource 106. For example, data storage devices 112 may store image data for various images displayed on landing resource 106. Image data may include actual images (e.g., image files), URL locations of images, image attributes, image metadata, or other qualities of the images displayed on landing resources 106.

Data storage devices 112 may be configured to store previous content items that have been used in conjunction with content requestors 104. Previous content items may include content items provided by content requestors 104, content items created by content generation system 114 for content requestors 104, images previously used or approved by content requestors 104, and/or other components of previously generated content items. Data storage devices 112 may be an image repository for on page images extracted from landing resources 106, images previously used or approved by content requestors 104, and/or other images that have not been extracted from landing resources 106 or approved by content requestors 104.

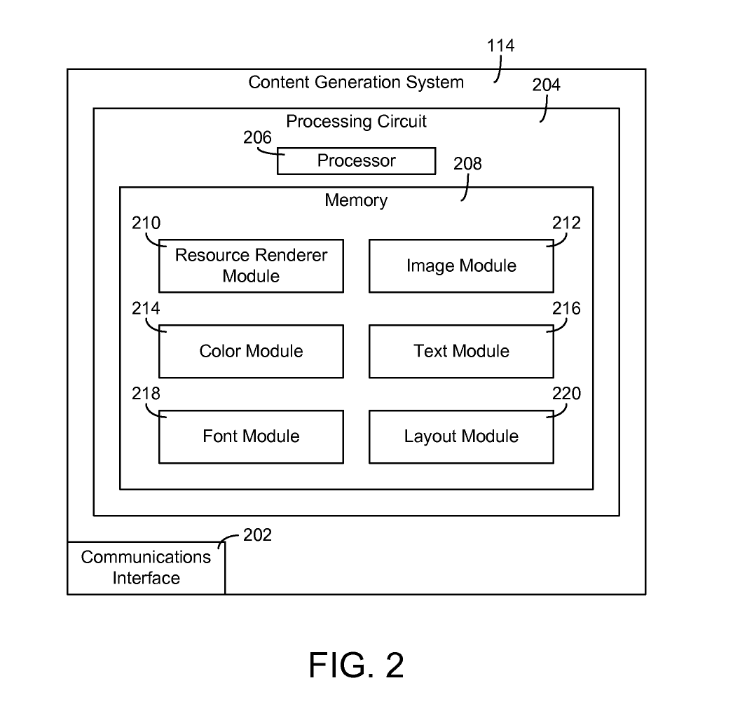

Still referring to FIG. 1, computer system 100 is shown to include a content generation system 114. Content generation system 114 may be configured to extract visual information (e.g., images, colors, texts, fonts, styles, etc.) from landing resources 106. Content generation system 114 may analyze the extracted images to detect the visual content and semantic content thereof. For example, content generation system 114 may determine a distribution of content in the extracted images (e.g., locations of salient objects, locations of text, etc.) and label the extracted images with a qualitative description of what the images represent (e.g., a type of car, a brand of shoe, etc.). Content generation system 114 may process the extracted images (e.g., crop, enhance, optimize, format, etc.) and select an image for use in a third-party content item. Content generation system 114 may create a third-party content item that includes the selected image and serve the created third-party content item to user devices 108. Content generation system 114 is described in greater detail with reference to FIG. 2.

Referring now to FIG. 2, a block diagram illustrating content generation system 114 in greater detail is shown, according to a described implementation. Content generation system 114 is shown to include a communications interface 202 and a processing circuit 204. Communications interface 202 may include wired or wireless interfaces (e.g., jacks, antennas, transmitters, receivers, transceivers, wire terminals, Ethernet ports, WiFi transceivers, etc.) for conducting data communications with local or remote devices or systems. For example, communications interface 202 may allow content generation system 114 to communicate with content requestors 104, resources 106, user devices 108, resource renderer 110, and other components of computer system 100.

Processing circuit 204 is shown to include a processor 206 and memory 208. Processor 206 may be implemented as a general purpose processor, an application specific integrated circuit (ASIC), one or more field programmable gate arrays (FPGAs), a CPU, a GPU, a group of processing components, or other suitable electronic processing components.

Memory 208 may include one or more devices (e.g., RAM, ROM, flash memory, hard disk storage, etc.) for storing data and/or computer code for completing and/or facilitating the various processes, layers, and modules described in the present disclosure. Memory 208 may include volatile memory or non-volatile memory. Memory 208 may include database components, object code components, script components, or any other type of information structure for supporting the various activities and information structures described in the present disclosure. In some implementations, memory 208 is communicably connected to processor 206 via processing circuit 204 and includes computer code (e.g., data modules stored in memory 208) for executing one or more processes described herein. In brief overview, memory 208 is shown to include a resource renderer module 210, an image module 212, a color module 214, a text module 216, a font module 218, and a layout module 220.

Still referring to FIG. 2, memory 208 is shown to include a resource renderer module 210. In some implementations, resource rendering is performed by resource renderer module 210 rather than an external resource rendering service (e.g., resource renderer 110). Resource renderer module 210 may include the functionality of resource renderer 110 as described with reference to FIG. 1. For example, resource renderer module 210 may be capable of interpreting landing resources 106 and creating a visual representation (e.g., an image, a display, etc.) thereof.

Resource renderer module 210 may identify a particular landing resource using a URL or other indicator provided by content requestors 104 as part of a request to generate content items. Resource renderer module 210 may read and interpret marked up content (e.g., HTML, XML, image URLs, etc.) and formatting information (e.g., CSS, XSL, etc.) from landing resources 106 and render landing resources 106 (e.g., according to W3C standards). Resource renderer module 210 may create a snapshot image of landing resources 106 and/or construct a DOM tree representing landing resources 106.

The snapshot image may be a visual representation of the identified landing resource 106. The snapshot image may illustrate the visual appearance of the landing resource 106 as presented on a user interface device (e.g., an electronic display screen, a computer monitor, a touch-sensitive display, etc.) after rendering landing resource 106. The snapshot image may include color information (e.g., pixel color, brightness, saturation, etc.) and style information (e.g., square corners, rounded edges, modern, rustic, etc.) for landing resource 106. In some implementations, the snapshot image may be a picture file having any viable file extension (e.g. .jpg, .png, .bmp, etc.).

The DOM tree may be a hierarchical model of the identified landing resource 106. The DOM tree may include image information (e.g., image URLs, display positions, display sizes, alt text, etc.), font information (e.g., font names, sizes, effects, etc.), color information (e.g., RGB color values, hexadecimal color codes, etc.) and text information for the landing resource 106. Resource renderer module 210 may store the snapshot image and/or DOM tree in memory 208 for subsequent use by other modules content generation system 114.

Still referring to FIG. 2, memory 208 is shown to include an image module 212. Image module 212 may be configured to extract images from landing resource 106. For example, image module 212 may parse the DOM tree for landing resource 106 to identify and extract images and image metadata (e.g., image URL, display position, display size, alt text, etc.). The image metadata may be used to determine an on-page saliency for each image displayed on landing resource 106. In some implementations, image module 212 extracts images and image metadata from other data sources (e.g., a repository of previously-used or approved images, a repository of stock images, etc.).

Image module 212 may analyze the extracted images to detect the visual content of the images. Detecting visual content may include, for example, determining a location of a salient object represented in the image, determining a location of text in the image, and/or determining whether the image can be cropped or processed to improve the visual impact of the image. In some implementations, the image module 212 analyzes the extracted images to detect the semantic content of the images. Detecting semantic content may include, for example, identifying an object depicted in an image or a meaning conveyed by an image. Image module 212 may assign one or more labels or keywords to an image describing the semantic content thereof. The labels and/or keywords can be used to determine a relevancy of the image to a particular third-party content item.

Image module 212 may process the images to prepare the images for use in a third-party content item. Image processing may include cropping the images to emphasize salient objects or to remove text, resizing the images, formatting the images, or otherwise adjusting the images. In some implementations, image module 212 identifies and enhances logo images.

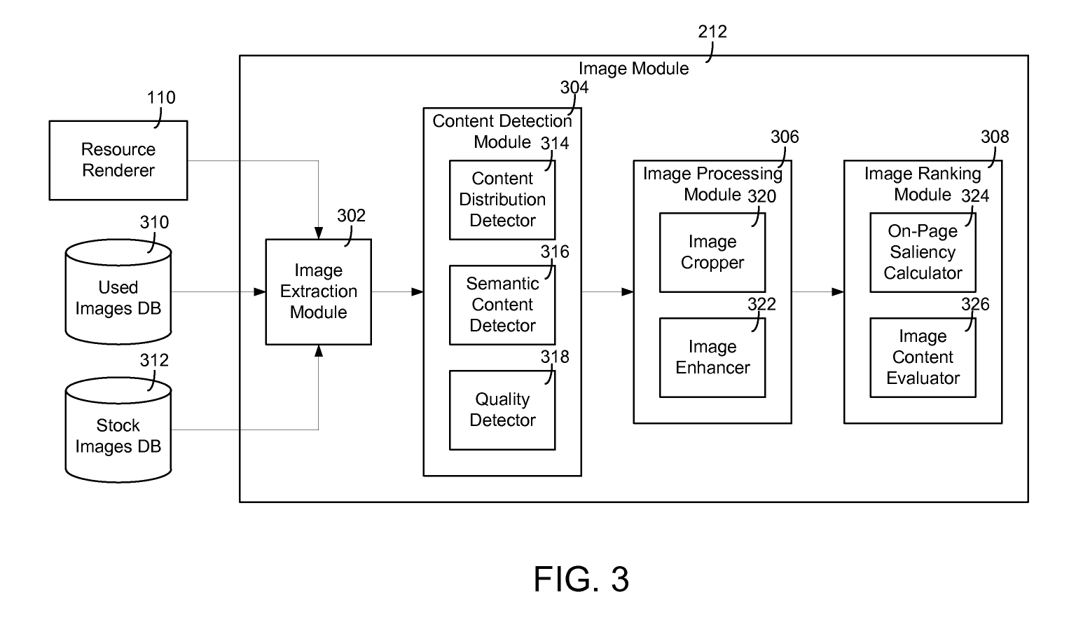

Image module 212 may filter and rank images based on various attributes of the images. Image module 212 may determine a quality score and/or on-page salience score for each of the images. The quality score for an image may indicate an aesthetic appearance of the image based on various image attributes. The salience score may indicate a prominence with which an extracted image is displayed on landing resource 106. Image module 212 may discard or filter images that have a display size less than a threshold display size or a quality score less than a threshold quality score. In some implementations, image module 212 ranks the images based on the salience scores associated with the images. Image module 212 may select the top ranking image or images for inclusion in a display content item. Image module 212 is described in greater detail with reference to FIG. 3.

Still referring to FIG. 2, memory 208 is shown to include a color module 214. Color module 214 may generate a color scheme for the display content. For example, color module 214 may select colors for the background, headline, description, button background, and/or button text of the content item. The color scheme may include one or more colors corresponding to the colors displayed on landing resource 106.

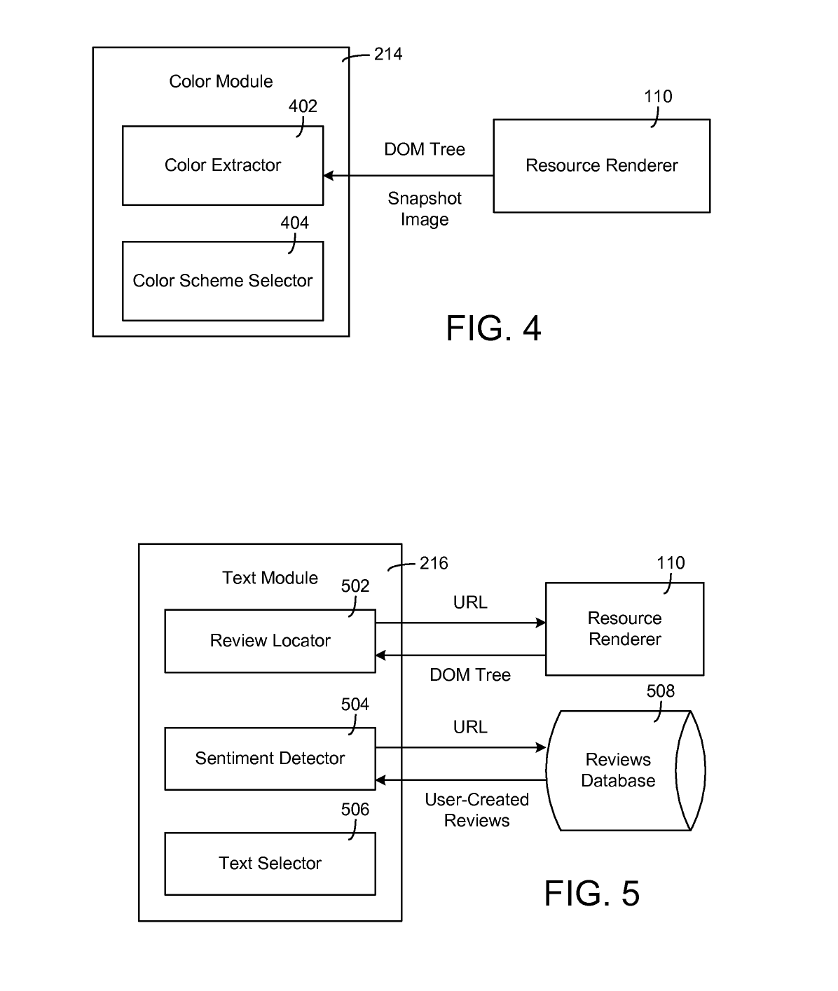

Color module 214 may use the snapshot image and/or DOM tree of landing resource 106 to select colors for the content item. In some implementations, color module 214 extracts several color clusters from the snapshot image using a clustering technique (e.g., k-means clustering). Color module 214 is described in greater detail in reference to FIG. 4.

Still referring to FIG. 2, memory 208 is shown to include a text module 216. Text module 216 may be configured to automatically create a textual portion of a third-party content item (e.g., a textual description, a headline, etc.). In various implementations, text module 216 may be used to create a text portion of a display content item or a purely textual content item. In some implementations, text module 216 uses the DOM tree or snapshot image of landing resource 106 to create a summary of the text displayed on landing resource 106. In some implementations, text module 216 retrieves textual data from other data sources in addition to or in place of landing resource 106. For example, text module 216 may receive textual data from user-created reviews of a business, product, or service. The reviews may be retrieved from an Internet resource (e.g., website) on which users are permitted to post or submit comments, reviews, or other text related to a particular business, product, or service. The URL of landing resource 106 may be used to specify the location of such reviews and/or direct text module 216 to a particular resource.

Text module 216 may include a sentiment detection system capable of determining whether a review is positive or negative with or without a numerically expressed rating (e.g., “1 out of 5,” “4 stars,” etc.). The sentiment detection system may parse the language of the review, looking for positive-indicating adjectives (e.g., excellent, good, great, fantastic, etc.). The sentiment detection system may then select or extract a relatively short snippet of the review that includes such positive phrases for inclusion in the generated content item. Text module 216 is described in greater detail in reference to FIG. 5.

Still referring to FIG. 2, memory 208 is shown to include a font module 218. Font module 218 may select a font or font family for use in the generated content item. In some implementations, landing resource 106 may include font information as HTML, CSS, or XML font tags. Font module 218 may use the rendered DOM tree for landing resource 106 to extract one or more fonts (e.g., font faces, font families, etc.). Font module 218 may extract font information from a rendered DOM tree of landing resource 106 or from landing resource 106 directly (e.g., using optical character recognition, etc.).

In some implementations, font module 218 separates the extracted fonts into multiple categories based on font size. For example, font module 218 may create a first category for large fonts (e.g., greater than 20 pt., greater than 16 pt., etc.) and a second category for relatively smaller fonts. Font size may be extracted from the rendered DOM tree or from landing resource 106 directly. In some implementations, font module 218 selects multiple fonts or font families for use in the third-party content item. For example, font module 218 may select a first font to use as a headline font for the generated content item and a second font to use as a font for a descriptive portion or button text of the content item.

Still referring to FIG. 2, memory 208 is shown to include a layout module 220. Layout module 220 may be configured to use the selected texts, images, colors, and fonts to generate a layout for the content item. Layout module 220 may select a layout from a set of predefined layout options (e.g., template layouts) or generate a new layout (e.g., not based on a template). Layout module 220 may generate a layout based on the display sizes of the images selected by image module 212 and/or the length of the text selected by text module 216. Layout module 220 may resize the image(s) and/or adjust the text to fit a selected layout or adjust the layout to fit the selected images and/or text.

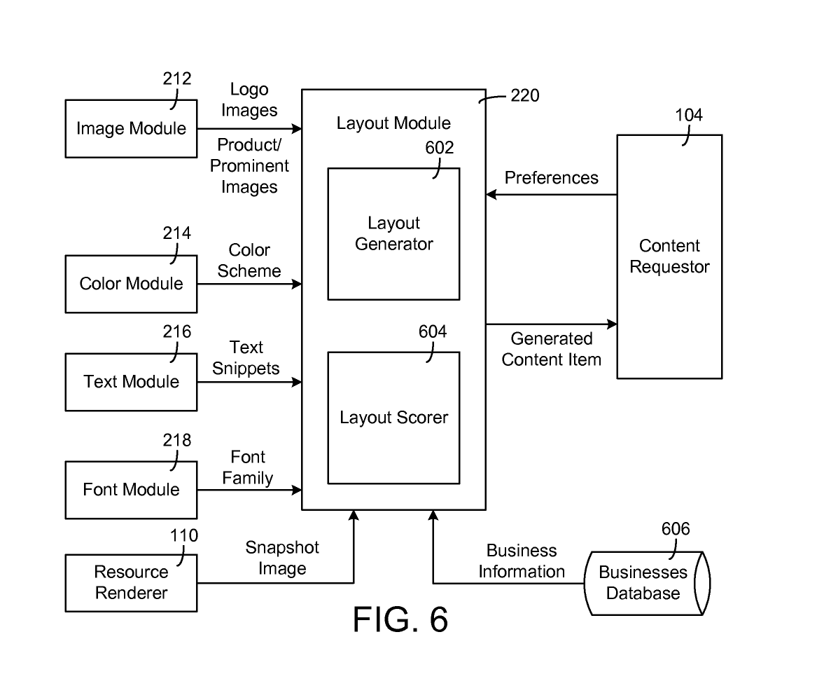

In some implementations, layout module 220 uses the visual information extracted from landing resource 106 to determine a style, business category, or appearance for the content item. For example, layout module 220 may determine a business category of landing resource 106 (e.g., fast food, automotive parts, etc.), a style of landing resource 106 (e.g., modern or rustic), and a usage of shapes (e.g., 90 degree corners, rounded corners, etc.) displayed on landing resource 106. Layout module 220 may invoke an external database to retrieve business category information based on the URL of landing resource 106. Layout module 220 is described in greater detail in reference to FIG. 6.

Referring now to FIG. 3, a block diagram illustrating image module 212 in greater detail is shown, according to a described implementation. Image module 212 is shown to include an image extraction module 302, a content detection module 304, an image processing module 306, and an image ranking module 308.

Image extraction module 302 may be configured to extract images from landing resource 106 and/or other data sources. For example, image extraction module 302 may receive a DOM tree for landing resource 106 from resource renderer 110. Image extraction module 302 may parse the DOM tree to identify and extract images and image metadata (e.g., image URLs, display positions, display sizes, alt text, etc.). In some implementations, image module 212 extracts images and image metadata from other data sources.

Other data sources from which image extraction module 302 can extract images are shown to include a used images database 310 and a stock images database 312. Used images database 310 may be a repository for all of the images used in previous content items that direct to the same landing resource 106 as the content item currently being generated (e.g., same URL, same domain, etc.). Used images database 310 may include images that have been provided by content requestors 104 and/or images that have previously been approved by content requestors 104. The images in used images database 310 may be stored with additional data (e.g., image metadata) such as keywords and other data associated with previous third-party content items in which the images were included.

Stock images database 312 may be a repository for a wide variety of images not necessarily associated with content requestors 104 or extracted from landing resource 106. Stock images database 312 may include images that have been extracted from other resources or otherwise provided to content generation system 114. In some implementations, image extraction module 302 determines a relevancy score of the images in databases 310-312 to the content item currently being generated (e.g., by comparing keywords, etc.). In some implementations, image extraction module 302 extracts from databases 310-312 only images that have a relevancy score exceeding a relevancy score threshold. Images extracted from used images database 310 and/or stock images database 312 may include, for example, business logos (e.g., trademark, service mark, etc.), pictures of a featured product, or other prominent images.

In some implementations, image extraction module 302 uses the image metadata to determine an on-page saliency for each image displayed on landing resource 106. The on-page saliency for an image may indicate the relative importance or prominence with which the image is displayed on landing resource 106. Image extraction module 302 may extract various attributes of the images such as the vertical placement of the image (e.g., top of the page, middle of the page, bottom of the page, etc.), the display size of the image (e.g., display height, display width, etc.), whether the image is centered on landing resource 106, the visual clutter around the image, and/or other attributes that may be relevant to on-page saliency.

In some implementations, image extraction module 302 extracts logo images. A logo image may be a trademark, a business logo, a product logo, a company logo, or any other image associated with a particular product, service, or organization. In some implementations, image extraction module 302 queries databases 310-312 to identify logo images previously submitted or approved by content requestors 104. In some implementations, databases 310-312 may be organized by URL or domain name such that logo information may be readily retrieved by specifying a URL. For example, image extraction module 302 may search databases 310-312 using the URL of landing resource 106. In various implementations, image extraction module 302 may identify a logo image from the set of images extracted from landing resource 106 (e.g. by URL) or from the images stored in databases 310-312.

In some implementations, databases 310-312 may contain no logo information for landing resource 106 or the domain associated with landing resource 106. When no logo information is available, image extraction module 302 may attempt to identify logo images using other techniques. In some implementations, image extraction module 302 searches landing resource 106 or the metadata associated with the extracted images for a special logo markup tag. One example of a special logo markup tag is:
<link rel=“example-logo-markup” href=“somepath/image.png”>
   where the text string ‘example-logo-markup’ is used as a keyword identifying a logo image. In other implementations, different text strings or keywords may be used. The particular text string or keyword may be selected based on the URL of landing resource 106, the domain associated with landing resource 106, a business entity associated with landing resource 106, or any other criteria. Any number of logo markup keywords may be used to identify a potential logo image. Image extraction module 302 may extract the ‘href’ attribute value (e.g., somepath/image.png) as a URL specifying the location of a potential logo image.

In some implementations, image extraction module 302 searches image metadata (e.g., HTML tags, URLs, display positions, display sizes, alt text, filenames, file sizes.) to identify a logo image. For example, image extraction module 302 may search for a text string or keyword indicative of a logo image (e.g. “logo”) in the image filenames, alt text, or title attributes.

Image extraction module 302 may generate a list, set, or compilation of the images extracted from landing resource 106, used images database 310, and/or stock images database 312. In some implementations, the images extracted from landing resource 106 may be stored in an images database (e.g., data storage devices 112, memory 208, etc.). The extracted images may be stored in conjunction with metadata and saliency criteria (e.g., as image URLs, display positions, display sizes, alt text, filenames, file sizes, etc.) for each image. The list of images generated by image extractor 252 and the information associated with each extracted image may be used to select one or more images for inclusion in the generated content item.

Still referring to FIG. 3, image module 212 is shown to include a content detection module 304. Content detection module 304 may be configured to analyze the images extracted by image extraction module 302 to detect the distribution of various types of content in the image (e.g., text, salient objects, faces, etc.), the semantic content of the images, and/or the aesthetic quality of the images.

In some implementations, content detection module 304 identifies the display size of each of the extracted images. If the display size for an image is less than a threshold display size (e.g., a threshold height, a threshold width, a threshold area, etc.) content detection module 304 may discard the image. In some implementations, content detection module 304 identifies the aspect ratio for each of the extracted images. Content detection module 304 may discard an image if the aspect ratio for the image is not within a predefined aspect ratio range (e.g., 0.2-5, 0.33-3, 0.5-2, etc.).

Content detection module 304 is shown to include a content distribution detector 314, a semantic content detector 316, and a quality detector 318. Content distribution detector 314 may be configured to detect the location, size, and/or distribution of content in the images extracted by image extraction module 302. Content distribution detector 314 may detect the distribution of various types of image content such as colors, edges, faces, and text.

In some implementations, content distribution detector 314 is configured to locate salient objects in the extracted images. Salient objects may be foreground objects, featured objects, or other objects that are displayed with prominence in the extracted images. In some implementations, content distribution detector 314 analyzes the distribution of color in the images to distinguish foreground objects from background colors. Content distribution detector 314 may identify edges in the extracted images to detect the boundaries between objects (e.g., foreground objects, background objects, side-by-side objects, etc.). Distinguishing salient objects from other objects may be useful in identifying the most meaningful or important areas of the images.

In some implementations, content distribution detector 314 is configured to detect text in the extracted images. Content distribution detector 314 may perform optical character recognition (OCR) on the extracted images to detect various types of text (e.g., headline text, creative text, call-to-action text, advertisement text, etc.). Some of the extracted images may themselves be advertisements that include their own creative text. Content distribution detector 314 may identify areas of the images that include text so that the text can be cropped or removed from the images.

In some implementations, content distribution detector 314 generates a saliency map for each of the extracted images. The saliency map may mark the locations of text, faces, and/or foreground objects in the images. For example, areas with text or faces may be identified by a list of rectangles. Foreground areas may be represented with a binary bitmap, lines, or boundary markers. Content distribution detector 314 may determine a size of the salient objects in the images relative to the image as a whole. If the salient object represented in an image is relatively small compared to the display size of the entire image (e.g., smaller than a threshold, smaller than a percentage of the overall display size, etc.), content distribution detector 314 may discard the image or remove the image from the list of images that are candidates for inclusion in the generated content item.

Still referring to FIG. 3, content detection module 304 is shown to include a semantic content detector 316. Semantic content detector 316 may be configured to analyze the images extracted by image extraction module 302 to detect the semantic content of the images. Detecting semantic content may include, for example, identifying an object depicted in an image or a meaning conveyed by an image. Semantic content detector 316 may use a visual search service (VSS), an image content annotation front end (ICAFE), and/or an image content annotation service (ICAS) to determine the semantic content of an image. Such services may be configured to receive an image (e.g., an image URL, an image file, etc.), analyze the image, and output various labels (e.g., titles, keywords, phrases, etc.) describing the content depicted in the image. Semantic content detector 316 may configure the image annotation and search services to use different modules (e.g., a logo module, a product module, etc.) to refine the keywords and labels generated for an input image.

Semantic content detector 316 may assign the labels or keywords to an image as attributes or tags thereof. For example, for an image of an AUDI® brand car, semantic content detector 316 may assign the image the keywords “car,” “sports car,” “Audi,” “Audi R8 V10” or other keywords qualitatively describing the content of the image. In some implementations, semantic content detector 316 may associate each keyword or label with a score indicating an estimated accuracy or relevance of the keyword or label to the image. The labels and/or keywords can be used by image ranking module 308 to determine a relevancy of the image to a particular third-party content item, search query, and/or electronic resource.

Still referring to FIG. 3, content detection module 304 is shown to include a quality detector 318. Quality detector 318 may be configured to determine a visual quality (e.g., an aesthetic quality) of the images extracted by image extraction module 302. The visual quality for an image may represent a human visual preference for the image based on visual features of the image such as exposure, sharpness, contrast, color scheme, content density, and/or other aesthetic qualities of the image.

Quality detector 318 may determine visual quality algorithmically by leveraging computer vision, clustering, and metadata for the images. For example, quality detector 318 may use the images or image features as an input to a ranking model trained on human-labeled image preferences. In some implementations, quality detector 318 compares the features of an image to the features of images that have previously been scored by humans to identify the aesthetic or visual quality of the image. Images that have features more closely matching the features of images scored highly by humans may be assigned a higher quality score by quality detector 318. Images that have features dissimilar to the features of images scored highly by humans may be assigned a lower quality score by quality detector 318.

Still referring to FIG. 3, image module 212 is shown to include an image processing module 306. Image processing module 306 may be configured to process the images extracted by image extraction module 302 to prepare the images for use in a content item. Image processing module 306 may receive the content detection results generated by content detection module 304 as an input and may output processed images. In various embodiments, processing the images may include cropping the images, formatting the images, enhancing the images, removing text from the images, or otherwise adjusting the images for use in an automatically-generated content item. Image processing module 306 is shown to include an image cropper 320 and an image enhancer 322.

Image cropper 320 may be configured to determine whether to crop each of the extracted images based on the distribution of the image content detected by content distribution detector 314. For example, image cropper 320 may use the saliency map generated by content distribution detector 314 to determine the areas of each image that contain salient objects (e.g., foreground objects), text, faces, and/or other types of detected content. The portions of the images that contain salient objects, text, and faces may be represented as rectangles in the saliency map. Image cropper 320 may identify a portion of each image to keep and a portion of each image to discard, using the distribution of content indicated by the saliency map.

In some implementations, image cropper 320 is configured to identify a portion of each image that contains a salient object. The location of a salient object in an image may be represented by content distribution detector 314 as a pair of vectors in the saliency map. For example, the location of a salient object may be indicated by a vertical vector and a horizontal vector that define a rectangle in the image. Image cropper 320 may determine the size and location of one or more rectangles containing a salient object within each image. For images that contain multiple salient objects, image cropper 320 may select one or more of the salient objects to keep and one or more of the salient objects to discard. In some implementations, image cropper 320 generates a rectangle that contains multiple salient objects. The rectangle generated by image cropper 320 may be the smallest possible rectangle that includes the multiple salient objects.

In some implementations, image cropper 320 determines the size of the rectangle containing a salient object relative to the total display size of the image (e.g., as a percentage of the total display size, as a proportion of the total area of the image, etc.). In some implementations, image cropper 320 determines an amount of space between an edge of a rectangle containing a salient object (e.g., a top edge, a bottom edge, a side edge, etc.) and an edge of the image. For example, image cropper 320 may identify a distance (e.g., number of pixels, etc.) between an edge of a rectangle containing a salient object and an edge of the image. Image cropper 320 may determine the distance between each edge of the rectangle and the corresponding edge of the image (e.g., the distance between the top edge of the rectangle and the top edge of the image, the distance between the bottom edge of the rectangle and the bottom edge of the image, etc.).

Image cropper 320 may determine whether to crop an image based on the size and position of a salient object within the image. For each image, image cropper 320 may calculate an area threshold based on the display size of the image (e.g., 80% of the display size, 66% of the display size, etc.). If the rectangle containing a salient object has an area exceeding the area threshold, image cropper 320 may determine that the image should not be cropped. If the rectangle containing the salient object has an area that is less than the area threshold, image cropper 320 may determine that the image should be cropped. In some implementations, image cropper 320 determines that an image should be cropped if the salient object occupies an area less than approximately one-third of the image.

Image cropper 320 may crop an image to remove some or all of the image content that does not contain a salient object. For example, image cropper 320 may crop an image such that only the rectangle containing the salient object remains. In some implementations, image cropper 320 crops an image to include the salient object rectangle and a border around the salient object rectangle.

In some implementations, image cropper 320 is configured to crop text from the images. Image cropper 320 may identify a portion of each image that includes text using the saliency map generated by content distribution detector 314. For example, image cropper 320 may identify one or more rectangles that indicate the position of text in the image. In some implementations, image cropper 320 determines a portion of the image to keep based on the areas of the image that contain salient objects and the areas of the image that contain text. For example, image cropper 320 may discard the portions of the image that contain text while keeping the portions of the image that contain salient objects. Image cropper 320 may crop text from the image by generating a rectangle that includes one or more rectangles containing salient objects and none of the rectangles containing text. In some implementations, image cropper 320 crops an image to include only the image content within the rectangle generated by image cropper 320 (e.g., salient objects, faces, etc.).

In some implementations, image cropper 320 is configured to crop a logo image from an image sprite. For example, some of the images extracted by image extraction module 302 may be a combination or compilation of individual button or logo images (e.g., a stitched canvas containing multiple logos in a grid). Image cropper 320 may be configured to determine the location of a logo image within the image sprite and crop the image sprite such that only the logo image remains.

Still referring to FIG. 3, image processing module 306 is shown to include an image enhancer 322. Image enhancer 322 may be configured to enhance or optimize the images extracted by image extraction module 302 for use in the generated content item. Enhancing or optimizing an image may include, for example, rounding the edges of the image, adding lighting effects to the image, adding texture or depth to the image, and/or applying other effects to enhance the visual impact of the image.

In some implementations, image enhancer 322 uses the content detection results produced by content detection module 304 to identify logo images. Some logo images may be extracted by image extraction module 302 as flat and simple logos. For example, landing resources 106 may rely on CSS or another content markup scheme to change the appearance of a flat/simple logo when the logo is rendered by user devices 108. Image enhancer 322 may process logo images to convert a flat/simple logo into an optimized logo by causing the logos to appear three-dimensional, adding depth or lighting effects, rounding corners, causing the logos to appear as buttons, optimizing the logos for display on mobile devices, or otherwise adjusting the logos to improve the visual impact thereof. Image processing module 306 may store the processed images in a data storage device.

Still referring to FIG. 3, image module 212 is shown to include and an image ranking module 308. Image ranking module 308 may be configured to rank the various images to determine which of the images to include in the generated content item. Image ranking module 308 is shown to include an on-page saliency calculator 324 and an image content evaluator 326.

On-page saliency calculator 324 may be configured to assign a salience score to each of the images extracted by image extraction module 302 based on a relative importance or prominence with which the image is displayed on landing resource 106. For example, the salience score for an image may depend on the vertical placement of the image (e.g., top of the page, middle of the page, bottom of the page, etc.), the display size of the image (e.g., display height, display width, etc.), whether the image is centered on landing resource 106, and/or other image salience scoring criteria.

One example of an image salience scoring algorithm that can be used by on-page saliency calculator 324 is:

Salience=α*sigmoid₁(position_{y},y₀,dy)+β*sigmoid₂(width,w₀,d_{size})*sigmoid₂(height,h₀,d_{size})+δ*central_alignment

In some implementations, α, β, and δ are all positive and sum to 1.0.
Sigmoid₁(position_{y},y₀,dy) may be a sigmoid function ranging from 1.0 at position_{y}=0 (e.g., the top of landing resource 106) to 0.0 at position_{y}=∞ (e.g., the bottom of landing resource 106, significantly distant from the top of landing resource 106, etc.). y₀ may be the point at which Sigmoid₁=0.5 and dy may control the slope of the sigmoid function around y₀. Sigmoid₂ may be defined as (1−Sigmoid₁) and central_alignment may be a measure of whether the image is centrally aligned (e.g., horizontally centered) on landing resource 106. Central_alignment may be 1.0 if the image is perfectly centered and may decrease based on the distance between the center of the image and the horizontal center of landing resource 106.

Image content evaluator 326 may rank the images extracted by image extraction module 302. In some implementations, the rankings are based on the salience scores assigned to each image. Salience scores may indicate the preferences of content requestors 104 for each of the extracted images and may be a valuable metric in determining which images are most likely to be approved by content requestors 104. Salience scores may also indicate how well the images correspond to the content featured on landing resource 106.

In some implementations, image content evaluator 326 ranks the images based on various relevancy criteria associated with the images. For example, image content evaluator 326 may use relevancy criteria to assign each image a relevancy score. Image content evaluator 326 may determine a relevancy score for an image by comparing the image (e.g., image metadata, image content, etc.) with a list of keywords based on the URL of landing resource 106 or the automatically-generated content item. For example, the list of keywords may be based on a business classification, business type, business category, or other attributes of the business or entity associated with landing resource 106. In some implementations, the list of keywords may be based on the title of the generated content item or other attributes of the content item (e.g., campaign, ad group, featured product, etc.). The relevancy score may indicate the likelihood that a particular image represents the business, product, or service featured in the automatically-generated content item.

In some implementations, content evaluator 326 performs one or more threshold tests prior to ranking the images. For example, content evaluator 326 may compare the quality score assigned to each image by quality detector 318 with a threshold quality score. If the quality score for an image is less than the threshold quality score, image ranking module 308 may discard the image. Content evaluator 326 may compare the display size of each of the extracted and processed images to a threshold display size. If the display size for an image is less than the threshold display size, image ranking module 308 may discard the image.

In some implementations, image content evaluator 326 generates multiple lists of images. One list generated by image content evaluator 326 may be a list of logo images. Another list generated by image content evaluator 326 may be a list of product and/or prominent images extracted from landing resource 106. Another list generated by image content evaluator 326 may be a list of images that have previously been used and/or approved by content requestors 104 (e.g., images extracted from used images database 310). The lists of images may include attributes associated with each image such as image width, image height, salience score, relevance score, or other image information. Image content evaluator 326 may arrange the images in the lists according to the saliency scores and/or relevancy scores assigned to the images. The lists of images may be used by layout module 220 to select images for inclusion in the automatically-generated content item.

Referring now to FIG. 4, a block diagram of color module 214 is shown, according to a described implementation. Color module 214 may generate a color scheme for the automatically-generated content item. Color module 214 may select colors for the background, headline, description, button background, and/or button text of the content item. Advantageously, the color scheme may include one or more colors corresponding to the colors displayed on landing resource 106. Color module 214 is shown to include a color extractor 402 and a color scheme selector 404.

In some implementations, color extractor 402 receives the rendered DOM tree of landing resource 106 from resource renderer 110. The DOM tree may provide color extractor 402 with images, background colors (e.g., hexadecimal color codes, color names, etc.), text colors, and/or other items displayed on landing resource 106. Color extractor 402 may estimate the dominant colors of landing resource 106 based on the information provided by the DOM tree.

In some implementations, color extractor 402 receives a snapshot image of landing resource 106 from resource renderer 110. The snapshot image may be received in addition to or in place of the rendered DOM tree. Advantageously, the snapshot image may provide color extractor 402 with supplemental color information not readily apparent from analyzing the DOM tree. For example, the snapshot image may accurately illustrate the visual appearance of landing resource 106 including actual display sizes of HTML elements and style information rendered by JAVASCRIPT. The snapshot image may be received as an image file (e.g., .png, .bmp, .jpg, etc.) illustrating the rendered appearance of landing resource 106.

Color extractor 402 may extract dominant colors from the snapshot image. In some implementations, color extractor 402 extracts dominant colors from the snapshot image using a clustering technique such as k-means clustering. For example, color extractor 402 may treat each pixel of the snapshot image as an independent color measurement (e.g., an independent k-means observation). The color of each pixel may be represented using RGB color values ranging from zero saturation (e.g., 0) to complete saturation (e.g., 255) for each primary color of light (e.g., red, green, and blue). Color extractor 402 may use a set of predefined colors (e.g., RGB(0, 0, 0), RGB(225, 0, 0), RGB(0, 255, 0), RGB(0, 0, 225), RGB(255, 255, 0), RGB(255, 0, 255), RGB(0, 255, 255), RGB(255, 255, 255), etc.) as initial cluster means and assign each pixel to the cluster with the mean value closest to the RGB color value of the pixel.

For example, the RGB color value of each pixel may be compared with each cluster mean using the following formula: |Rₘₑₐₙ−Rₚᵢₓₑₗ|+|Gₘₑₐₙ−Gₚᵢₓₑₗ|+|Bₘₑₐₙ−Bₚᵢₓₑₗ|=difference. In some implementations, a new mean may be created if the difference between the RGB color value for a pixel and the closest cluster mean exceeds a threshold value (e.g. |Rₘₑₐₙ−Rₚᵢₓₑₗ|+|Rₘₑₐₙ−Gₚᵢₓₑₗ|+|Bₘₑₐₙ−Bₚᵢₓₑₗ>threshold). After assigning each pixel to the closest cluster (e.g., the cluster having a mean value closest to the color value for the pixel), each mean cluster value may be re-computed based on the RGB color values of the pixels in each cluster. In some implementations, successive iterations may be performed by reassigning pixels to the closest cluster until the clusters converge on steady mean values or until a threshold number of iterations has been performed.

Color extractor 402 may rank the refined color clusters based on the number of pixels in each cluster. For example, the color cluster with the most pixels may be ranked as expressing the most dominant color, the color cluster with the second most pixels may be ranked as expressing the second most dominant color, etc. In some implementations, color extractor 402 may assign a weight to each color based on the number of pixels in the corresponding color cluster relative to the total number of pixels in the snapshot image. Color extractor 402 may generate a list of extracted colors (e.g., RGB values) along with a weight or dominance ranking of each color.

Advantageously, k-means clustering may provide a color extraction technique which does not increase in time_complexity as a function of the square of the number of pixels in the snapshot image (e.g., time_complexity ≠K*nₚᵢₓₑₗₛ²). Instead, k-means clustering has a time complexity proportional to the number of pixels multiplied by the number of clustering iterations (e.g. time_complexity=K*nₚᵢₓₑₗₛ*iterations). The linear relationship between pixel number and time_complexity with k-means clustering may result in an improved computation time over other color extraction techniques, especially when extracting colors from relatively large snapshot images.

In some implementations, color extractor 402 filters advertisements and/or other third party content before extracting dominant colors from the snapshot image. For example, color extractor 402 may maintain or receive a list of third party content providers. Color extractor 402 may parse the rendered DOM tree for content items originating from a third party content provider and eliminate such third party content as well as any dependent content from the rendered DOM tree. Color extractor 402 may also remove such content from the snapshot image based on the runtime position and display size of the third party content items.

Still referring to FIG. 4, color module 214 is further shown to include a color scheme selector 404. Color scheme selector 404 may use the colors determined by color extractor 402 to generate a color scheme for the automatically-generated content item. Color scheme selector 404 may select a color for a background color, button color, headline color, description color, button text color, or other portions of the generated content item. Color scheme selector 404 may determine the saturation, brightness, noticeability, and/or other attributes of each extracted color as well as the contrast between each of the extracted colors.

In some implementations, color scheme selector 404 may select the most dominant color (e.g., heaviest weighted, highest dominance ranking, etc.) extracted by color extractor 402 as the background color for the content item. Color scheme selector 404 may select the extracted color with the highest multiplied saturation and weight (e.g., max(saturation*weight)) as the button color for the content item. Color scheme selector 404 may select the colors with the highest contrast and/or brightness differences with the selected background color as the colors for the headline and description text. If more than two colors are available, color scheme selector 404 may select the more noticeable color as the headline color.

In other implementations, color scheme selector 404 may select a predefined color scheme for the content item. The predefined color scheme may be used to select the background color, button color, headline color, description color, button text color, or other portions of the generated content item rather than directly applying the colors extracted by color extractor 402. The predefined color scheme may be a combination of colors previously assembled into a color template or color group. In some implementations, the predefined color scheme may be selected from a set of predefined color schemes based on the colors extracted by color extractor 402. For example, color scheme selector 404 may compare the colors extracted by color extractor 402 with the colors included in a plurality of predefined color schemes. Color scheme selector 404 may rank the predefined color schemes based on the differences (e.g., RGB values, saturation, brightness, contrast, etc.) between one or more of the colors extracted by color extractor 402 and one or more of the colors included in the predefined color scheme. Colors from a predefined color scheme may supplement or replace colors identified by color extractor 402 in the automatically-generated content item.

Referring now to FIG. 5, a block diagram of text module 216 is shown, according to a described implementation. In some implementations, text module 216 may be used to automatically create a textual portion of the display content generated by content generation system 114 (e.g., textual description, headline, etc.). In other implementations, text module 216 may be used to independently generate purely textual content items. Advantageously, text module 216 may automatically generate a “creative” portion of a content item (e.g., a text-based description, persuasive text, positive sentiment, etc.), thereby eliminating the need for a content provider to spend time writing the creative or employ a copywriter to develop the creative. Text module 216 is shown to include a review locator 502, a sentiment detector 504, and a text selector 506.

In some implementations, text module 216 uses the DOM tree or snapshot image of landing resource 106 to create a summary of the text displayed on landing resource 106. For example, text module 216 may receive the rendered DOM tree from resource renderer 110 and extract textual the textual information displayed on landing resource 106. In other implementations, text module 216 obtains textual data from sources other than landing resource 106. For example, text module 216 may receive textual data from user-created reviews of a business, product, or service.

Still referring to FIG. 5, text module 216 is shown to include a review locator 502. Review locator 502 may search a reviews database 508 for user-created reviews. In some implementations, the reviews may apply to a business as a whole. In other implementations, the reviews may apply to a particular product or service associated with landing resource 106 (e.g., featured, displayed, presented, etc. on landing resource 106). Reviews database 508 may be an Internet resource (e.g., website) on which users are permitted to post comments, submit reviews, evaluate products and/or services, or otherwise communicate their opinions regarding a particular business. For example, reviews database 508 may be a website such as Google+Local, ZAGAT, YELP, URBANSPOON, or other resource through which user-created reviews are obtained.

In some implementations, review locator 502 may use the URL of landing resource 106 to locate such reviews and/or direct text module 216 to a particular resource or portion of a resource dedicated to reviews of a particular business. For example, the URL of landing resource 106 may be used to specify a portion of reviews database 508 on which reviews pertaining to the business entity associated with landing resource 106 may be obtained. In some implementations, review locator 502 may search multiple resources for user-created reviews pertaining to the business identified by landing resource 106. In some implementations, review locator 502 may transcribe audio-based or video-based reviews to generate textual reviews for further analysis.

Still referring to FIG. 5, text module 216 is further shown to include a sentiment detector 504. Sentiment detector 504 may be configured to determine whether a review is positive or negative with or without a numerically expressed rating (e.g., “1 out of 5,” “4 stars,” etc.). Sentiment detector 504 may parse the language of the review, looking for adjectives indicative of a generally positive sentiment (e.g., excellent, good, great, fantastic, etc.). Sentiment detector 504 may analyze a portion of a review, the entire text of a review, or the text of a review in conjunction with a numerically expressed rating to identify reviews expressing a generally positive sentiment

Text selector 506 may search the reviews for a “snippet” (e.g., phrase, text string, portion, etc.) which, when read in isolation, effectively communicates why the user who submitted the review had a positive experience with the reviewed business, product, or service. The “snippet” may include one or more of the positive adjectives used by sentiment detector 504 in identifying a sentiment associated with the review. For example, text selector 506 may select the snippet “excellent pasta and speedy service” from a relatively lengthy review of an Italian restaurant. In some implementations, the text snippets identified by text selector 506 may be presented to a content requestors 104 as potential “creatives” (e.g., descriptive text) for use in purely-textual content items. In other implementations, the text snippets may be used as a textual portion of one or more display content items generated by content generation system 114.

Referring now to FIG. 6, a block diagram of layout module 220 is shown, according to a described implementation. Layout module 220 may generate a layout for the automatically-generated content item. Layout module 220 may receive a list of logo images and a list of product/prominent images from image module 212. Each list of images may identify several images and rank each image (e.g., with a salience score, relevance score, etc.) Layout module 220 may further receive one or more selected color schemes from color module 214 and one or more selected font families from font module 218. The selected color schemes and selected font families may be received with scores assigned to each. Layout module 220 may further receive a selection of text snippets from text module 216. The selected text snippets may have any length and may include any number of snippets.

In some implementations, layout module 220 may receive a snapshot image of landing resource 106 from resource renderer 110. Layout module 220 may use the snapshot image to determine a style (e.g., modern, rustic, etc.), and/or visual appearance (e.g., usage of shapes, square corners, rounded corners, etc.) of landing resource 106. Layout module 220 may invoke a businesses database 606 to obtain business information for landing resource 106. The business information may specify a category of business associated with landing resource 106 (e.g., fast food, automotive parts, etc.) as well as other attributes of the associated business.

Still referring to FIG. 6, layout module 220 is shown to include a layout generator 602. Layout generator 602 may generate a layout for the content item based on the identified images, text snippets, color scheme, and font family. For example, layout generator 602 may use the display sizes (e.g., height, width, etc.) of the images identified by image module 212 as well as the lengths of the text snippets identified by text module 216 to create a layout for the content item.

In some implementations, layout generator 602 selects a layout from a set of predefined layout options (e.g., template layouts). Template layouts may include a predefined position and display size for text, images, action buttons and/or other features of the content item. Layout generator 602 may resize the image(s) and/or adjust the text to fit a selected layout. In other implementations, layout generator 602 creates a new layout for the content item.

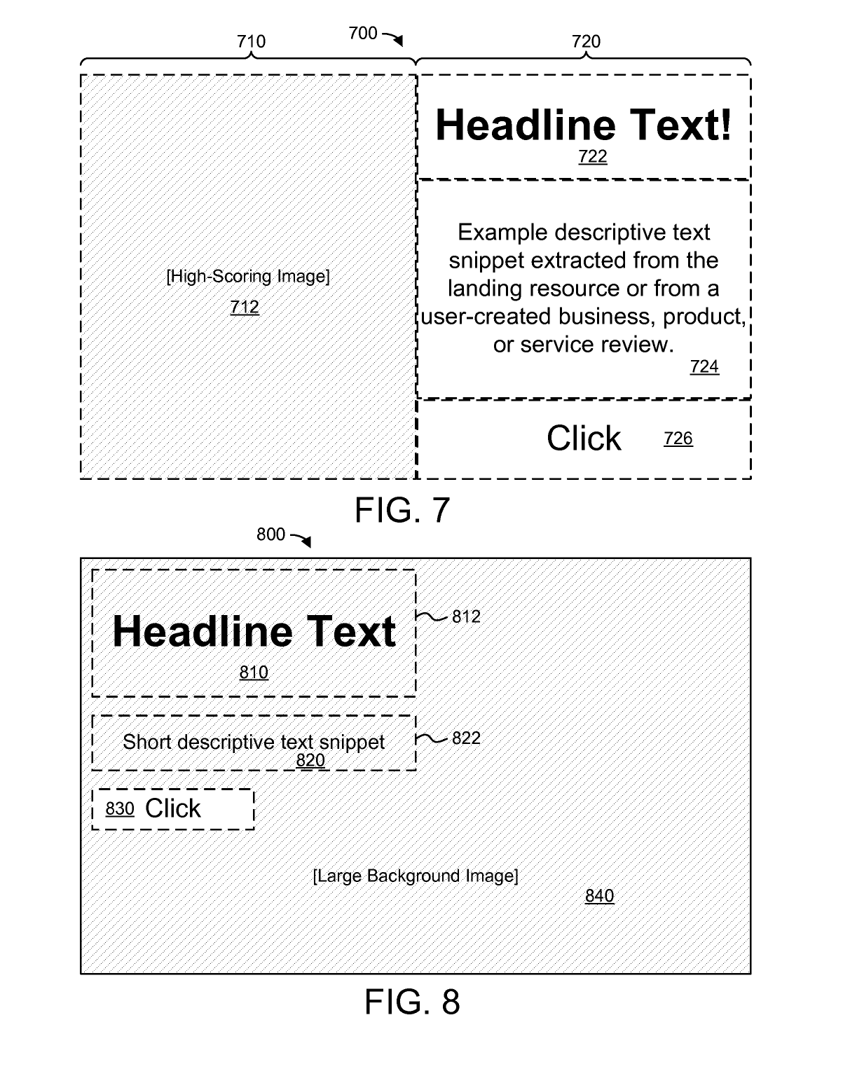

Advantageously, the new layout may not based on a template or predefined design, thereby resulting in a unique-looking content item. Non-template layout designs are described in greater detail in reference to FIGS. 7-12.

Still referring to FIG. 6, layout module 220 is further shown to include a layout scorer 604. Layout scorer 604 may assign a numeric score to various layouts generated by layout generator 602. The overall score for a content item may be based on the individual scores (e.g., image salience, color cluster weights, etc.) of the selected images, text snippets, colors, and fonts used in the content item. In some implementations, the assigned score may be based on how efficiently space is used in the content item (e.g., a ratio of empty space to utilized space), how well the selected images and selected text fit the generated layout (e.g., the degree of cropping or stretching applied to images), how well the colors in the selected images match the other colors displayed in the content item, readability of text (e.g., contrast between text color and background color, usage of sans-serif fonts, etc.), and/or other aesthetic criteria (e.g., usage of the “golden ratio,” padding around the outer perimeter of the content item, spacing between images, text, and other components of the content item, etc.). Scoring criteria may further include the relative locations of images, text, and action button in the content item. For example, a higher score may be assigned to content items having an image, text, and action button arranged in descending order from the top right corner of the content item to the bottom left corner of the content item.

Referring now to FIGS. 7-12 several non-template layout designs are shown, according to a described implementation. The non-template layout designs may be based on a set of flexible layout generation criteria. Advantageously, the flexible layout generation criteria may result in layouts which adapt to the attributes of the images, text snippets, fonts, and colors selected by modules 212-220 of content generation system 114. This adaptive layout criteria may result in unique-looking content items (e.g., not based on templates) which are tailored to a particular landing resource.

For example, referring specifically to FIG. 7, layout generator 602 may create a “half and half” layout 700 when a particularly high scoring image (e.g., an image with a salience score or relevance score exceeding a threshold value) is provided by image module 212. Layout 700 is shown to include a first half 710 and a second half 720. Half 710 may be dedicated to displaying the high-scoring image 712 whereas half 720 may be used to display a headline text (e.g., text box 722), descriptive text (e.g., text box 724), and/or an action button 726. Headline text 722 and descriptive text 724 may be extracted from landing resource 106 or from a user-created business, product, or service review. Action button 726 may include “call-to-action” text (e.g., “click here,” “buy now,” “read more,” etc.) enticing a user to click the generated content item.

In some implementations, the relative sizes of text boxes 722,724 and action button 726 may be adjusted based on the length of the text snippet selected by text module 216 and/or the font selected by font module 218. An image displayed on half 710 may be resized (e.g., cropped, stretched, compressed, etc.) to fit the dimensions of half 710. In some implementations, half 710 may be positioned to the left of half 720. In other implementations, half 710 may be positioned to the right of half 720 (e.g., for landscape content items) or above/below half 720 (e.g., for portrait content items).

Referring now to FIG. 8, layout generator 602 may create a “text overlay” layout 800 when an image with a large display size is provided by image module 212. Layout 800 is shown to include headline text 810, descriptive text 820, action button 830, and a background image 840. Headline text 810 and descriptive text 820 may be contained within transparent or translucent text boxes 812 and 822 such that background image 840 is visible behind the presented text. In some implementations, text boxes 812,822 may be translucently shaded to provide contrast between the colors of text 810,820, and background image 840. The translucent shading may improve readability of the presented text 810,820 when overlaid onto background image 840. For layouts in which the color of headline text 810 or descriptive text 820 is dark (e.g., black, brown, dark blue, etc.), text boxes 812 and/or 822 may be shaded white or another light color. Action button 830 may be opaque, transparent, or translucently shaded. Layout 800 may allow a large background image 840 to be displayed without substantially resizing or cropping background image 840. The display sizes and display positions of headline text 810, descriptive text 820, and action button 830 may be adjusted based on the length of the text snippets selected by text module 216 and the font family selected by font module 218.

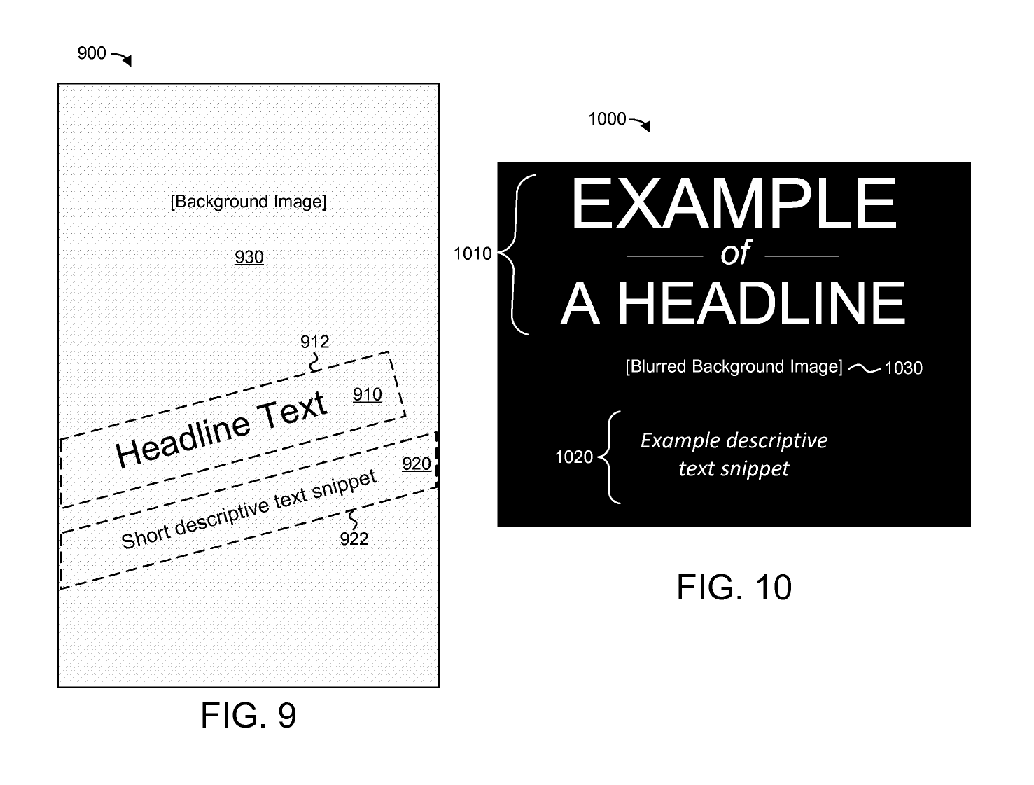

Referring now to FIG. 9, layout generator 602 may create a “slanted text” layout 900 when a high-scoring image is provided by image module 212 and the text snippets selected by text module 216 are relatively short. Layout 900 is shown to include headline text 910, descriptive text 920, and a background image 930. Background image 930 may fill the entire space of the content item, thereby providing a relatively large depiction of a product, service, or business featured in the content item. Headline text 910 and descriptive text 920 may be overlaid onto background image 930. Texts 910,920 may be slanted relative to the edges of the content item. Headline text 910 and descriptive text 920 may be contained within transparent or translucent text boxes 912 and 922 to provide contrast between the colors of text 910,920, and background image 940. The translucent shading may improve readability of the presented text 910,920 when overlaid onto background image 940.

Referring now to FIG. 10, layout generator 602 may create a “blurred background” layout 1000. Layout 1000 is shown to include headline text 1010, descriptive text 1020, and a blurred background image 1030. Headline text 1010 is shown to include the words “example of a headline.” In some implementations, layout generator 602 may search the text snippets provided by text module 216 for transition words. Transition words may be short words such as “in,” “on,” “for,” “of,” “and,” etc. linking two parts of a text snippet. Layout generator 602 may stylize (e.g., italicize, bold, enhance, etc.) the transition word and/or place the transition word on a separate line in the content item. Background image 1030 may be blurred, faded, or otherwise obscured. Advantageously, blurring background image 1030 may focus a reader's attention on the textual portion of the content item. The fonts for headline text 1010 and descriptive text 1020 may be specified by font module 218 based on the fonts extracted from landing resource 106.

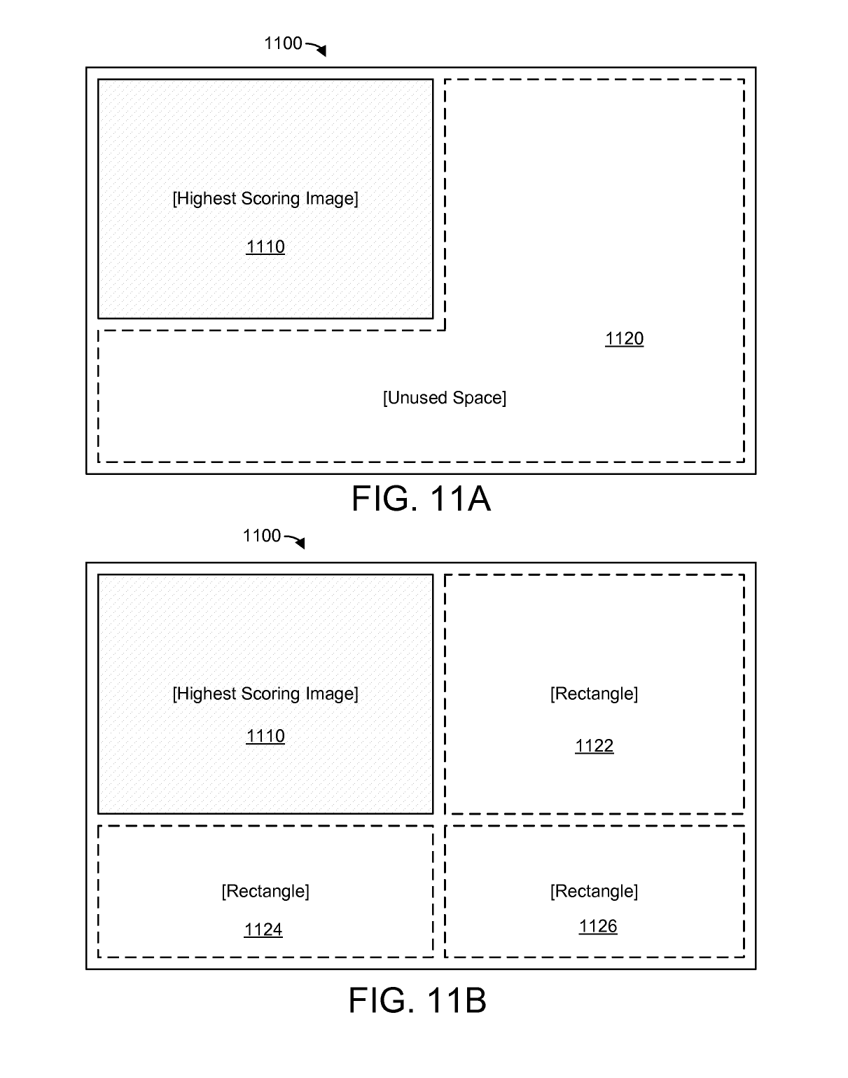

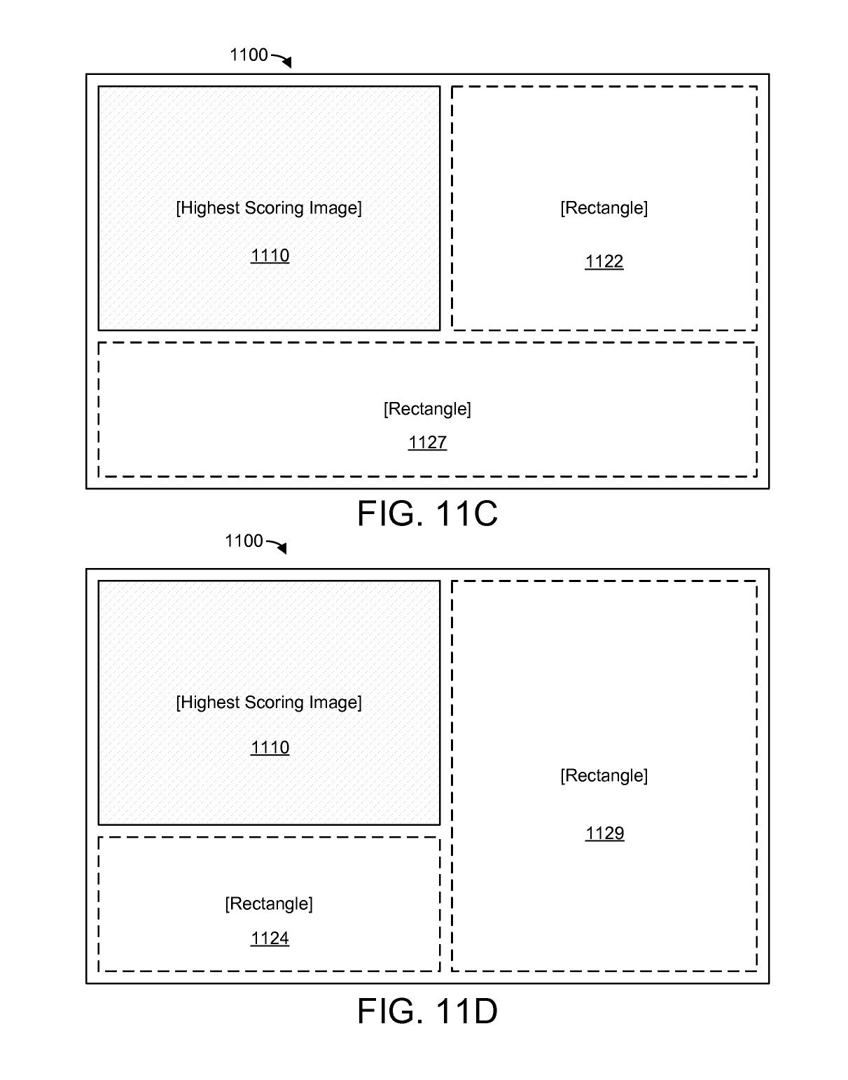

Referring now to FIGS. 11A-11D, layout generator 602 may create a flexible layout 1100 when the display sizes of the selected images and text snippets do not fill the entire content item. For example, layout generator 602 may place the highest scoring logo or product/prominent image 1110 in a corner (e.g., top left, top right, bottom left, bottom right) of the content item. Layout generator 602 may divide the remaining unused space 1120 into one or more rectangles (e.g., rectangles 1122, 1124, 1126 as shown in FIG. 11B). In some implementations, layout generator 602 may combine one or more of the rectangles into a larger rectangle. Referring specifically to FIG. 11C, rectangles 1124 and 1126 are shown combined into a larger rectangle 1127. Referring specifically to FIG. 11D, rectangles 1122 and 1126 are shown combined into a larger rectangle 1129.

Layout generator 602 may combine one or more rectangles based on the display sizes or aspect ratios of the remaining unused text snippets selected by text module 216 and/or images selected by image module 212. For example, if an unused image has a display height attribute (e.g., 400 pixels, 200 pixels, etc.) which exceeds the unused image's display width attribute (e.g., 200 pixels, 10 pixels, etc.) layout generator 602 may combine rectangles 1122 and 1126 to create a “portrait-style” rectangle 1129 (e.g., a rectangle having a display height which exceeds the rectangle's display width). Advantageously, the unused space may be allocated as necessary to accommodate the aspect ratios, display sizes, and display lengths of the remaining unused images and/or text snippets.

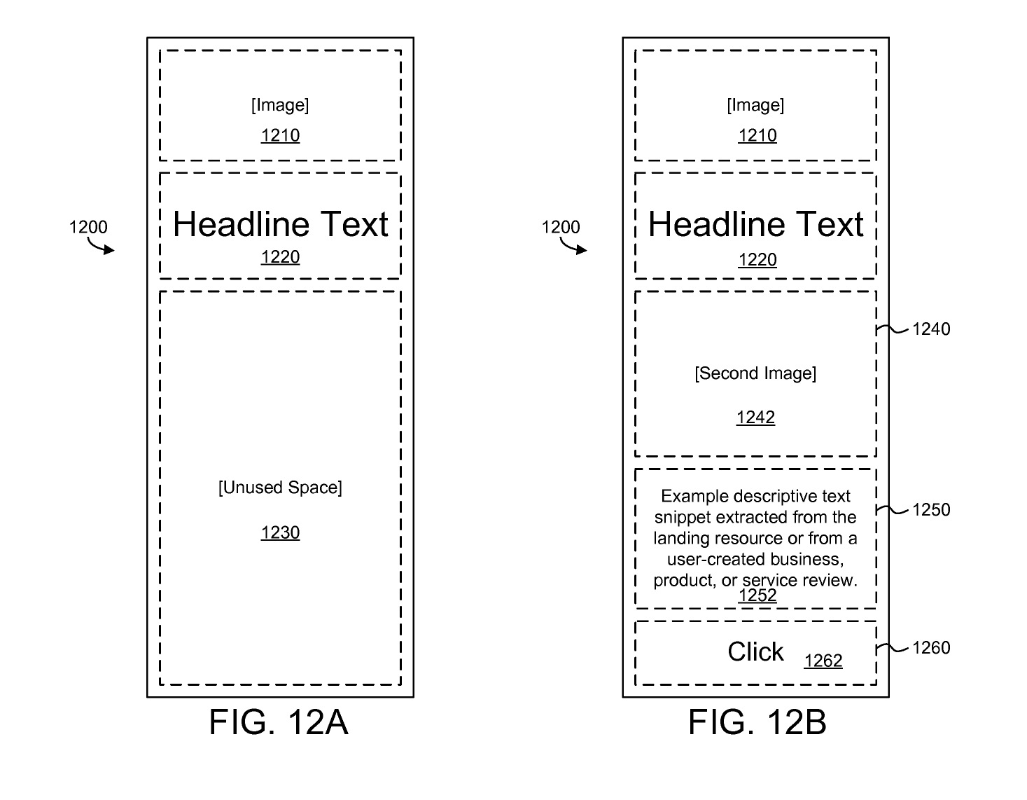

Referring now to FIGS. 12A and 12B, a flexible layout 1200 for banner-style content items is shown, according to a described implementation. Referring specifically to FIG. 12A, flexible layout 1200 is shown to include an image 1210, headline text 1220, and unused space 1230. Layout generator 602 may create layout 1200 by initially placing a high-scoring image 1210 and headline text 1220 within the content item. Image 1210 may be placed along the top, bottom, side, middle, or corner of the content item. Headline text 1220 may be placed in a suitable location within the content item such that the headline text 1220 does not overlap image 1210. Headline text 1220 may be placed below image 1210, above image 1210, beside image 1210, or elsewhere within the content item. Advantageously, the locations of image 1210 and headline text 1220 are flexible because layout 1200 is not based on a preconfigured template design. After placing image 1210 and text 1220, layout generator 602 may determine an amount of unused space 1230 remaining within the content item.

Referring specifically to FIG. 12B, layout generator 602 may divide unused space 1230 into one or more rectangles (e.g., rectangles 1240, 1250, and 1260). In some implementations, the display sizes or aspect ratios of the rectangles may be based on the display sizes and/or aspect ratios of remaining unused text snippets selected by text module 216 or unused images selected by image module 212. Layout 1200 is shown to include a second image 1242 placed in a first rectangle 1240, a descriptive text snippet 1252 placed in a second rectangle 1250, and an action button 1262 placed in a third rectangle 1260.

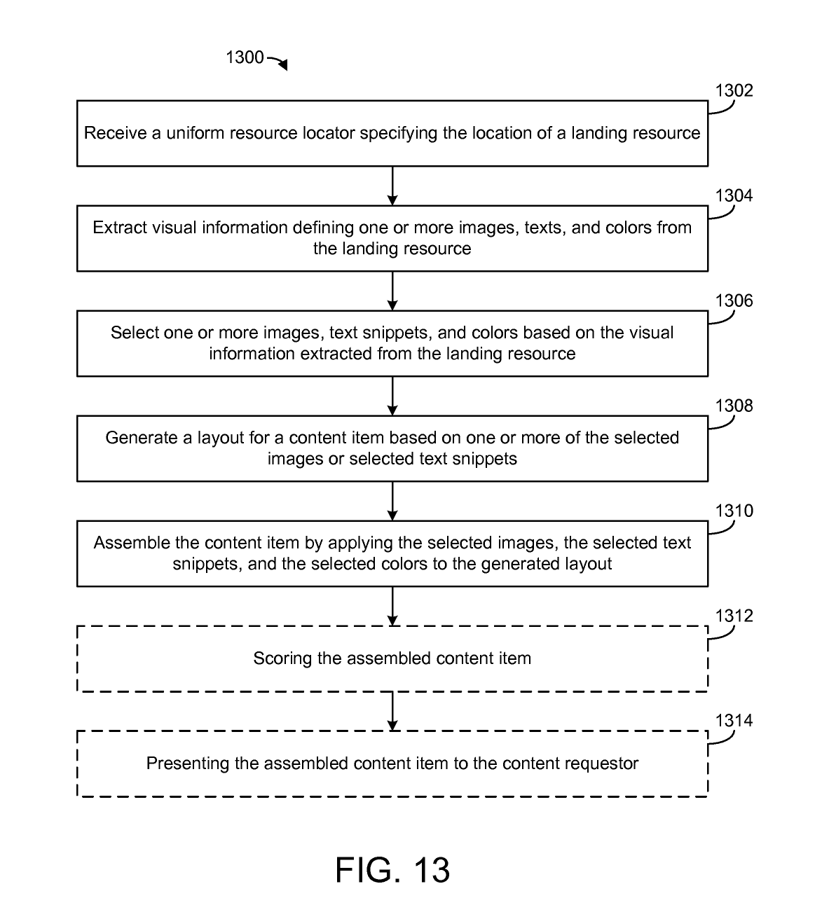

Referring now to FIG. 13, a flowchart of a process 1300 for automatically generating display content is shown, according to a described implementation. Process 1300 is shown to include receiving a uniform resource locator (URL) specifying the location of a landing resource (step 1302). The URL may be received from a content requestor as part of a request to generate content items. The URL may specify the location of a landing resource to which a user device is directed when the generated content item is “clicked.” The landing resource may be displayed on a user interface device (e.g., a monitor, touch screen, or other electronic display) in response to a user clicking (e.g., with a mouse) or otherwise activating the generated content item. The landing resource may be a webpage, a local resource, an intranet resource, an Internet resource, or other network resource. In some implementations, the landing resource may provide additional information relating to a product, service, or business featured in the automatically generated content item. For example, the landing resource may be a website through which a product or service featured in the generated content item may be purchased.

Still referring to FIG. 13, process 1300 is further shown to include extracting visual information defining one or more images, texts, and colors from the landing resource (step 1304). In some implementations, the visual information includes the images, colors, and text actually displayed on the landing resource when the landing resource is rendered. Step 1304 may involve rendering the landing resource using a resource renderer (e.g., a web browser or other rendering-capable hardware or software component) and generating a DOM tree or snapshot image of the rendered landing resource. In other implementations, the visual information includes metadata and other code (e.g., HTML code, CSS code, etc.) not directly visible from a snapshot image of the landing resource. The hidden code and metadata may define the locations (e.g., URLs), display sizes, display locations (e.g., top of the landing resource, middle of the landing resource, etc.), and other relevant attributes of images (e.g., alt text, special logo markup tags, etc.) displayed on the landing resource. The hidden code and metadata may also define font names, font families, colors, and text displayed on the landing resource. The visual information may be define a particular business, product, or service displayed on the landing resource.

Still referring to FIG. 13, process 1300 is further shown to include selecting one or more images, text snippets, and colors based on the visual information extracted from the landing resource (step 1306). In some implementations, step 1306 includes selecting one or more images, text snippets and colors actually displayed on the landing resource. Selecting a displayed image may include scoring or ranking the images extracted from the landing resource and selecting an image based on the assigned scores. Scores may be assigned to an image based on the metadata (e.g., a URL, a display position, a display size, alt text, etc.) associated with the image. In some implementations, scores may be assigned to an image based on whether the metadata associated with the image contains a specified keyword which selects for logo images. For example, the keyword may be a special logo markup tag such as link rel=“example-logo-markup”.

In some implementations, selecting a displayed color may include extracting one or more colors from a snapshot image of the landing resource. Each pixel of the snapshot image may be treated as an independent color measurement and dominant colors may be extracted using a clustering technique such as k-means clustering. For example, several initial color clusters may be established and labeled with an initial color value (e.g., RGB color values, hexadecimal color codes, etc.) Each pixel in the snapshot image may be assigned to the color cluster having a color value closest to the color value of the pixel. After assigning each pixel to the closest cluster, the mean color value of each cluster may be re-computed based on the color values of the pixels in the cluster. In some implementations, successive iterations may be performed by reassigning pixels to the cluster having the closest mean color value until the clusters converge on steady mean values or until a threshold number of iterations has been performed. Step 1306 may involve assigning a weight to each color based on the number of pixels in the corresponding color cluster relative to the total number of pixels in the snapshot image. The color(s) with the greatest weight may be selected for inclusion in the automatically-generated content item.

In some implementations, selecting a text displayed on the landing resource may involve parsing the HTML DOM tree for text and generating a summary of the text displayed on the landing resource. In other implementations, the snapshot image may be analyzed and text may be extracted from the rendered image using optical character recognition (OCR) or other text recognition techniques. The summary text may be a continuous text string displayed on the landing resource or a summary assembled from text fragments displayed in various locations on the landing resource.

In some implementations, step 1306 includes selecting one or more images, text snippets and/or colors not actually displayed on the landing resource. For example the visual information extracted from the landing resource may identify a particular business, product, or service. An image (e.g., a business logo, trademark, service mark, etc.) may be selected from a set of previously stored logo images based on the identity of the business, product, or service displayed regardless of whether the logo image is actually displayed on the landing resource. A color scheme may be selected from a set of previously-assembled (e.g., automatically, manually, etc.) color schemes based on the colors extracted from the landing resource. In some implementations, a color scheme may be selected regardless of whether any of the colors included in the color scheme are actually displayed on the landing resource. In some implementations, a text snippet may be selected from hidden metadata, HTML code, or other text not actually displayed on the landing resource. For example the visual information extracted from the landing resource may identify a particular business, product, or service. This identity may be used to locate a corpus of user-created reviews relating to the particular business, product, or service and a text snippet may be selected from one or more of the user-created reviews.

Still referring to FIG. 13, process 1300 is further shown to include generating a layout for a content item based on one or more of the selected images or selected text snippets (step 1308). Step 1308 may involve placing a high scoring logo or product/prominent image in a corner (e.g., top left, top right, bottom left, bottom right), edge (e.g., top, bottom, left, right), or middle (e.g., not an edge or corner) of a content item and dividing the remaining unused space into one or more rectangles. The amount of space remaining may be based on the display size of the image placed in the content item. In some implementations, one or more of the rectangles may be combined into a larger rectangle based on the display sizes or aspect ratios of the remaining text snippets and images. For example, if an unused image has a display height attribute (e.g., pixels, inches, etc.) which exceeds the unused image's display width attribute (i.e., a “portrait-style” image), rectangles may be combined to create a “portrait-style” space into which the image may be placed. Advantageously, the unused space may be allocated as necessary to accommodate the aspect ratios or display sizes of the remaining unused images as well as the lengths of any unused text snippets.

In some implementations, step 1308 may involve receiving a snapshot image of the landing resource and using the snapshot image to determine a style (e.g., modern, rustic, etc.), and/or visual appearance (e.g., usage of shapes, square corners, rounded corners, etc.) of the landing resource. Step 1308 may involve invoking a businesses database to obtain business information for the landing resource. The business information may specify a category of business associated with the landing resource (e.g., fast food, automotive parts, etc.) as well as other attributes of the associated business. The layout generated by step 1308 may be based on the style information and/or the business information.

Still referring to FIG. 13, process 1300 is further shown to include assembling the content item by applying the selected images, the selected text snippets, and the selected colors to the generated layout (step 1310). In some implementations, the selected images and text snippets may be cropped or resized to fit within designated placeholders in the generated layout. In other implementations, the placeholders may be resized, moved, or re-arranged to accommodate the selected images and/or text. The selected colors may be applied to the content item as background colors, text colors, button colors, translucent text box shading colors, border colors, or any other color visible in the generated content item.

In some implementations, process 1300 may further include scoring the assembled content item (step 1312) and presenting the assembled content item to the content requestor (step 1314). The overall score for a content item may be based on the individual scores (e.g., image salience, color cluster weights, etc.) of the selected images, text snippets, colors, and fonts used in the content item. In some implementations, the assigned score may be based on how efficiently space is used in the content item (e.g., a ratio of empty space to utilized space), how well the selected images and selected text fit the generated layout (e.g., the degree of cropping or stretching applied to images), how well the colors in the selected images match the other colors displayed in the content item, readability of text (e.g., contrast between text color and background color, usage of sans-serif fonts, etc.), and/or other aesthetic criteria (e.g., usage of the golden ratio, padding around the outer perimeter of the content item, spacing between images, text, and other components of the content item, etc.). Scoring criteria may further include the relative locations of images, text, and action button in the content item. For example, a higher score may be assigned to content items having an image, text, and action button arranged in descending order from the top right corner of the content item to the bottom left corner of the content item.

The completed content item may be presented to the content requestor along with other automatically-generated content items. The content requestor may approve or reject the automatically-generated content item. If approved, the content item may be used in conjunction with the content requestor's established content display preferences and delivered to a user interface device via content slots on one or more electronically-presented resources. In some implementations, the images, text snippets, colors, and/or layout of an approved content item may be recorded. The recorded data may be used to generate subsequent content items for the same content requestor or a different content requestor. For example, an approved logo image (e.g., a business logo, product logo, etc.) may be used in subsequent content items generated for the same content requestor. An approved layout may be used as a flexible template when generating content items for other content requestors. Advantageously, the input received from content requestors (e.g., approving or rejecting content items) may complete a feedback loop for adaptively designing, configuring, or generating content items.

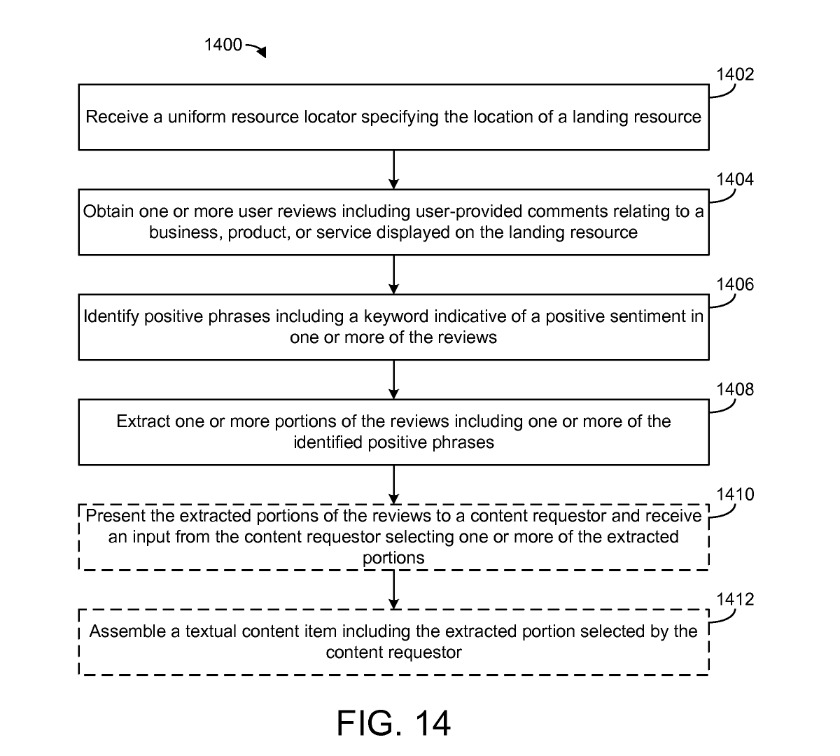

Referring now to FIG. 14, a flowchart of a process 1400 for automatically generating a textual portion of a content item is shown, according to a described implementation. In some implementations, process 1400 may be used to automatically create a textual portion (e.g., textual description, headline, etc.) of a content item which also includes images, colors, or other non-textual elements. In other implementations, process 1400 may be used to independently create purely textual content items. Advantageously, process 1400 may automatically generate a “creative” portion of a content item (e.g., a text-based description, persuasive text, positive sentiment, etc.), thereby eliminating the need for a content provider to spend time writing the creative or employ a copywriter to develop the creative.

Process 1400 is shown to include receiving a uniform resource locator specifying the location of a landing resource (step 1402). The URL may be received from a content requestor as part of a request to generate content items. The URL may specify the location of a landing resource to which a user device is directed when the generated content item is “clicked.” The landing resource may be displayed on a user interface device (e.g., a monitor, touch screen, or other electronic display) in response to a user clicking (e.g., with a mouse) or otherwise activating the generated content item. The landing resource may be a webpage, a local resource, an intranet resource, an Internet resource, or other network resource. In some implementations, the landing resource may provide additional information relating to a product, service, or business featured in the automatically generated content item. For example, the landing resource may be a website through which a product or service featured in the generated content item may be purchased

Still referring to FIG. 14, process 1400 is shown to further include obtaining one or more user reviews including user-provided comments relating to a business, product, or service displayed on the landing resource (step 1404). In some implementations, the reviews may apply to a business as a whole. In other implementations, the reviews may apply to a particular product or service associated with the landing resource (e.g., featured, displayed, presented, etc. on the landing resource). The user-provided reviews may be obtained from a reviews database. The reviews database may be an Internet resource (e.g., website) on which users are permitted to post comments, submit reviews, evaluate products, services, or otherwise communicate their opinions regarding a particular business. For example, the reviews database may be a website such as Google+ Local, ZAGAT, YELP, URBANSPOON, or other resource through which user-created reviews may be obtained.

In some implementations, step 1404 may involve using the URL of the landing resource to locate such reviews or to identify a particular resource or portion of a resource dedicated to reviews of a particular business. For example, the URL of the landing resource may be used to specify a portion of the reviews database on which reviews pertaining to the business entity associated with the landing resource may be obtained. Step 1404 may involve searching multiple resources for user-created reviews pertaining to the business identified by the landing resource. In some implementations, step 1404 may involve transcribing audio-based or video-based reviews to generate textual reviews for further analysis.

Still referring to FIG. 14, process 1400 is further shown to include identifying positive phrases including a keyword indicative of a positive sentiment in one or more of the reviews (step 1406). Step 1406 may be performed to determine whether a review is positive or negative with or without a numerically expressed rating (e.g., “1 out of 5,” “4 stars,” etc.). Step 1406 may involve parsing the language of the review, looking for adjectives indicative of a positive sentiment (e.g., excellent, good, great, fantastic, etc.). Step 1406 may involve analyzing a portion of a review, the entire text of a review, or the text of a review in conjunction with a numerically expressed rating to identify reviews expressing a positive sentiment. Positive phrases including one of the specified keywords may be identified in reviews expressing a positive sentiment.

Still referring to FIG. 14, process 1400 is further shown to include extracting one or more portions of the reviews including one or more of the identified positive phrases (step 1408). Step 1408 may involve searching the reviews for a “snippet” (e.g., phrase, text string, portion, etc.) which, when read in isolation, effectively communicates why the user who submitted the review had a positive experience with the reviewed business, product, or service. The snippet may include one or more of the positive phrases identified in step 1406.

In some implementations, process 1400 further includes presenting the extracted portions of the reviews to a content requestor and receiving an input from the content requestor selecting one or more of the extracted portions (step 1410). The content requestor may approve or reject the extracted text snippets. Advantageously, the input received from content requestors (e.g., approving or rejecting content items) may complete a feedback loop for adaptively designing, configuring, or generating content items. If approved, the extracted text may be assembled into a content item (step 1412). In some implementations, the extracted text may be used as a textual portion (e.g., textual description, headline, etc.) of a content item which also includes images, colors, or other non-textual elements (e.g., a display content item). In other implementations, the extracted text may be part of a purely textual content item (e.g., a textual “creative”).

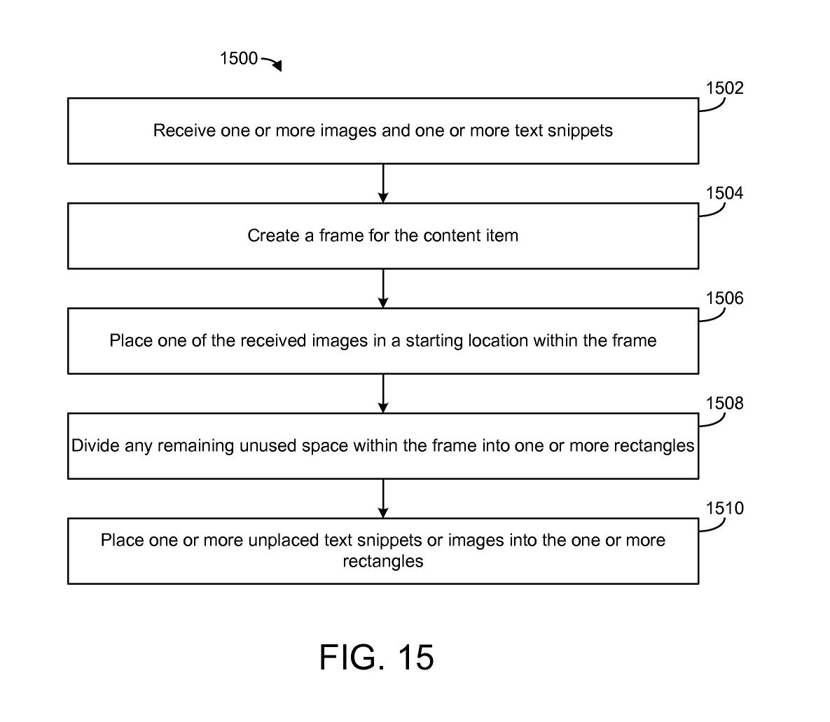

Referring now to FIG. 15, a flowchart of a process 1500 for automatically generating unique-looking layouts for a content item is shown, according to a described implementation. Process 1500 may be used to accomplish steps 1308 and 1310 of process 1300. For example, once a set of images, text snippets, fonts, and colors have been extracted from the landing resource, process 1500 may be used to assemble the images, text snippets, colors, and fonts into a completed content item.

Process 1500 is shown to include receiving one or more images and one or more text snippets (step 1502). In some implementations, step 1502 may further include receiving one or more fonts and one or more colors in addition to the received images and text snippets. Images may be received with a classification tag specifying whether the image is a logo image, a product/prominent image, or whether the image belongs to any other category of images. Each of the received images may include attribute information (e.g., a display height, a display width, a list of dominant colors in the image, etc.) Each of the received text snippets may include a length attribute. The length attribute may specify a display size for the text snippet and may depend on the font (e.g., font size, font family, etc.) used in conjunction with the text snippet. In some implementations, images, text snippets, colors, and fonts may be received along with a score, ranking, weight, or other scoring metric. The score associated with each element may be used to determine a priority or order in which the elements are selected for inclusion in the generated content item.

Still referring to FIG. 15, process 1500 is shown to further include creating a frame for the content item (step 1504). The frame for the content item may be a rectangular or non-rectangular frame corresponding to the dimensions (e.g., display height, display width, etc.) of the content item. In some implementations, step 1504 may involve creating multiple frames corresponding to multiple potential display sizes or dimensions for the completed content item. For example, several differently sized content items may be generated using several differently sized frames.

Process 1500 is further shown to include placing one of the received images in a starting location within the frame (step 1506). The image selected for initial placement may be chosen based on the score assigned to the image (e.g., the highest scoring image), the display size of the image, a classification of the image (e.g., logo, product, other prominent image), or a predicted score based on how well the image coordinates with the text snippets, colors, and/or fonts also potentially included in the content item. The initial image may be placed in a corner (e.g., top left, top right, bottom left, bottom right), edge (e.g., top, bottom, left, right), or middle of the frame (e.g., not along an edge or corner).

Still referring to FIG. 15, process 1500 is shown to further include dividing any remaining unused space within the frame into one or more rectangles (step 1508). The amount of space remaining may be based on the display size and/or position of the initial image placed within the frame in step 1506. In some implementations, one or more of the rectangles may be combined into a larger rectangle based on the display sizes or aspect ratios of the remaining unused text snippets and images. For example, if an unused image has a display height attribute (e.g., pixels, inches, etc.) which exceeds the unused image's display width attribute (i.e., a “portrait-style” image), rectangles may be combined to create a “portrait-style” space into which the image may be placed. Advantageously, the unused space may be allocated as necessary to accommodate the aspect ratios or display sizes of the remaining unused images as well as the lengths of any unused text snippets.

Process 1500 is shown to further include placing one or more of the unplaced text snippets or images into the one or more rectangles (step 1510). In some implementations, the selected images and text snippets may be cropped or resized to fit within designated placeholders in the generated layout. In other implementations, the placeholders may be resized, moved, or re-arranged to accommodate the selected images and/or text. The images and text snippets selected for placement into the one or more rectangles may be based on the display sizes of the images, the display length of the text snippets, and/or the scores assigned to each of the unused images and text snippets.

In some implementations, step 1510 may include applying the received colors and fonts to the generated layout. The received colors may be applied to the layout as background colors, text colors, button colors, translucent text box shading colors, border colors, or any other color visible in the generated content item. The received fonts may be applied to the text snippets placed within the frame, a headline text, button text, or any other text displayed in the generated content item.

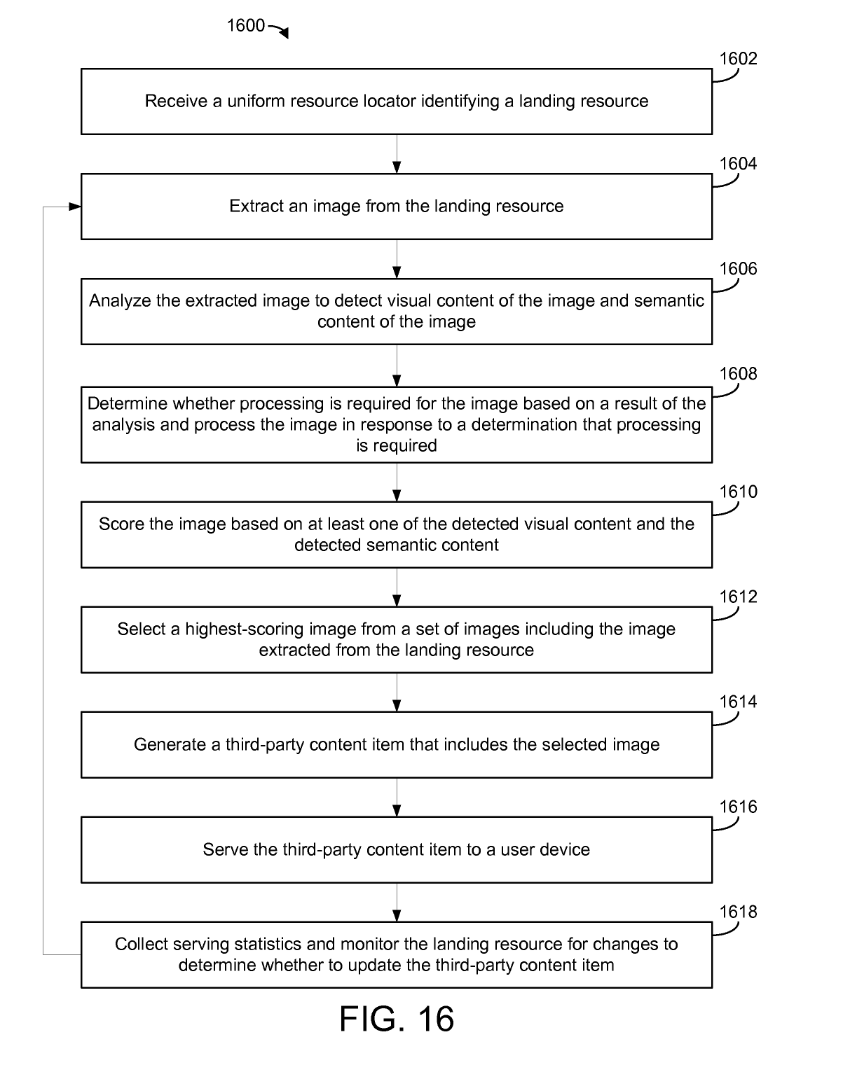

Referring now to FIG. 16, a flowchart of a process 1600 for automatically generating display content is shown, according to a described implementation. Process 1600 may be performed by content generation system 114 as described with reference to FIGS. 2-6 using one or more memory modules thereof (e.g., image module 212, color module 214, text module 216, font module 218, layout module 220, etc.). In some implementations, process 1600 may be performed substantially by image module 212 to extract images from landing resource 106, analyze and process the extracted images, and rank the images for use in an automatically-generated display content item.

Process 1600 is shown to include receiving a uniform resource locator (URL) identifying a landing resource (step 1602). The URL may be received from a content requestor (e.g., content requestors 104) as part of a request to generate content items. The URL may specify the location of a landing resource (e.g., landing resource 106) to which user devices 108 are directed when user devices 108 interact with the generated content item. The landing resource may be a webpage, a local resource, an intranet resource, an Internet resource, or other network resource. In some implementations, the landing resource provides additional information relating to a product, service, or business featured in the automatically generated content item. For example, the landing resource may be a website through which a product or service featured in the generated content item may be purchased.

Still referring to FIG. 16, process 1600 is shown to include extracting an image from the landing resource (step 1604). Step 1604 may be performed by image extraction module 302 as previously described with reference to FIG. 3. For example, step 1604 may include receiving a DOM tree for the landing resource from a resource renderer (e.g., resource renderer 110, resource renderer module 210, etc.). Step 1604 may include parsing the DOM tree to identify and extract images and image metadata (e.g., image URLs, display positions, display sizes, alt text, etc.).

In some implementations, step 1604 includes extracting images and image metadata from other data sources in addition to the landing resource. Other data sources from which images can be extracted may include a used images database (e.g., database 310) and/or a stock images database (e.g., database 312). The used images database may be a repository for all of the images used in previous content items that direct to the same landing resource as the content item currently being generated (e.g., same URL, same domain, etc.). The used images database may include images that have been provided by the content requestor and/or images that have previously been approved by the content requestor. The images in used the images database may be stored with additional data (e.g., image metadata) such as keywords and other data associated with previous third-party content items in which the images were included.

The stock images database may be a repository for a wide variety of images not necessarily associated with the content requestor or extracted from the landing resource. The stock images database may include images that have been extracted from other resources or otherwise provided to the content generation system. Images extracted from the used images database and the stock images database may include, for example, business logos (e.g., trademark, service mark, etc.), pictures of a featured product, or other prominent images.

Still referring to FIG. 16, process 1600 is shown to include analyzing the extracted image to detect visual content of the image and semantic content of the image (step 1606). In some implementations, step 1606 may be performed by content detection module 304 as previously described with reference to FIG. 3. In some implementations, step 1606 includes determining the display size of each of the extracted images. If the display size for an image is less than a threshold display size (e.g., a threshold height, a threshold width, a threshold area, etc.) step 1606 may include discarding the image. In some implementations, step 1606 includes determining the aspect ratio for each of the extracted images. Step 1606 may include discarding an image if the aspect ratio for the image is not within a predefined aspect ratio range (e.g., 0.2-5, 0.33-3, 0.5-2, etc.).

Analyzing the extracted images to detect visual content may include detecting the location, size, and/or distribution of content in each extracted image. In some implementations, step 1606 includes locating salient objects in the extracted images. Salient objects may be foreground objects, featured objects, or other objects that are displayed with prominence in the extracted images. In some implementations, step 1606 includes analyzing the distribution of color in the images to distinguish foreground objects from background colors. Step 1606 may include identifying edges in the extracted images to detect the boundaries between objects (e.g., foreground objects, background objects, side-by-side objects, etc.). Distinguishing salient objects from other objects may be useful in identifying the most meaningful or important areas of the images.

In some implementations, detecting the visual content of the extracted images includes detecting text. Step 1606 may include performing optical character recognition (OCR) on the extracted images to detect various types of text (e.g., headline text, creative text, call-to-action text, advertisement text, etc.). Some of the extracted images may themselves be advertisements that include their own creative text. Step 1606 may include identifying areas of the images that include text so that the text can be cropped or removed from the images.

In some implementations, step 1606 includes generating a saliency map for each of the extracted images. The saliency map may mark the locations of text, faces, and/or foreground objects in the images. For example, areas with text or faces may be identified by a list of rectangles. Foreground areas may be represented with a binary bitmap, lines, or boundary markers. Step 1606 may include determining a size of the salient objects in the images relative to the image as a whole. If the salient object represented in an image is relatively small compared to the display size of the entire image (e.g., smaller than a threshold, smaller than a percentage of the overall display size, etc.), step 1606 may include discarding the image or removing the image from the list of images that are candidates for inclusion in the generated content item.

Analyzing the extracted images to detect semantic content may include identifying an object depicted in an image or a meaning conveyed by an image. Step 1606 may include using a visual search service (VSS), an image content annotation front end (ICAFE), and/or an image content annotation service (ICAS) to determine the semantic content of an image. Such services may be configured to receive an image (e.g., an image URL, an image file, etc.), analyze the image, and output various labels (e.g., titles, keywords, phrases, etc.) describing the content depicted in the image. Step 1606 may include configuring the image annotation and search services to use different modules (e.g., a logo module, a product module, etc.) to refine the keywords and labels generated for an input image.

Step 1606 may include assigning the labels or keywords to an image as attributes or tags thereof. For example, for an image of an AUDI® brand car, step 1606 may include assigning the image the keywords “car,” “sports car,” “Audi,” “Audi R8 V10” or other keywords qualitatively describing the content of the image. In some implementations, includes associating each keyword or label with a score indicating an estimated accuracy or relevance of the keyword or label to the image. The labels and/or keywords can be used to determine a relevancy of the image to a particular third-party content item, search query, and/or electronic resource.

In some implementations, step 1606 includes determining a visual quality (e.g., an aesthetic quality) of the extracted images. The visual quality for an image may represent a human visual preference for the image based on visual features of the image such as exposure, sharpness, contrast, color scheme, content density, and/or other aesthetic qualities of the image. Step 1606 may include determining visual quality algorithmically by leveraging computer vision, clustering, and metadata for the images. For example, step 1606 may include using the images or image features as an input to a ranking model trained on human-labeled image preferences. In some implementations, step 1606 includes comparing the features of an image to the features of images that have previously been scored by humans to identify the aesthetic or visual quality of the image. Images that have features more closely matching the features of images scored highly by humans may be assigned a higher quality in step 1606. Images that have features dissimilar to the features of images scored highly by humans may be assigned a lower quality score in step 1606.

Still referring to FIG. 16, process 1600 is shown to include determining whether processing is required for the image based on a result of the analysis and processing the image in response to a determination that processing is required (step 1608). In some implementations, step 1608 is performed by image processing module 306 as described with reference to FIG. 3. Step 1608 may include processing the images extracted in step 1604 to prepare the images for use in a content item. In various implementations, step 1608 includes cropping the images, formatting the images, enhancing the images, removing text from the images, or otherwise adjusting the images for use in an automatically-generated content item.

Step 1608 may include determining whether to crop each of the extracted images based on the distribution of the image content detected in step 1606. For example, step 1608 may include using a saliency map generated in step 1606 to determine the areas of each image that contain salient objects (e.g., foreground objects), text, faces, and/or other types of detected content. The portions of the images that contain salient objects, text, and faces may be represented as rectangles in the saliency map. Step 1608 may include identifying a portion of each image to keep and a portion of each image to discard, using the distribution of content indicated by the saliency map.

In some implementations, step 1608 includes identifying a portion of each image that contains a salient object. The location of a salient object in an image may be represented as a pair of vectors in the saliency map. For example, the location of a salient object may be indicated by a vertical vector and a horizontal vector that define a rectangle in the image. Step 1608 may include determining the size and location of one or more rectangles containing a salient object within each image. For images that contain multiple salient objects, step 1608 may include selecting one or more of the salient objects to keep and one or more of the salient objects to discard. In some implementations, step 1608 includes generating a rectangle that contains multiple salient objects. The rectangle generated in step 1608 may be the smallest possible rectangle that includes the multiple salient objects.

In some implementations, step 1608 includes determining the size of the rectangle containing a salient object relative to the total display size of the image (e.g., as a percentage of the total display size, as a proportion of the total area of the image, etc.). In some implementations, step 1608 includes determining an amount of space between an edge of a rectangle containing a salient object (e.g., a top edge, a bottom edge, a side edge, etc.) and an edge of the image. For example, step 1608 may include identifying a distance (e.g., number of pixels, etc.) between an edge of a rectangle containing a salient object and an edge of the image. Step 1608 may include determining the distance between each edge of the rectangle and the corresponding edge of the image (e.g., the distance between the top edge of the rectangle and the top edge of the image, the distance between the bottom edge of the rectangle and the bottom edge of the image, etc.).

Step 1608 may include determining whether to crop an image based on the size and position of a salient object within the image. For each image, step 1608 may include calculating an area threshold based on the display size of the image (e.g., 80% of the display size, 66% of the display size, etc.). If the rectangle containing a salient object has an area exceeding the area threshold, step 1608 may include determining that the image should not be cropped. If the rectangle containing the salient object has an area that is less than the area threshold, step 1608 may include determining that the image should be cropped. In some implementations, step 1608 includes determining that an image should be cropped if the salient object occupies an area less than approximately one-third of the image.

Step 1608 may include cropping an image to remove some or all of the image content that does not contain a salient object. For example, step 1608 may include cropping an image such that only the rectangle containing the salient object remains. In some implementations, step 1608 includes cropping an image to include the salient object rectangle and a border around the salient object rectangle.

In some implementations, step 1608 includes text from the images. Step 1608 may include identifying a portion of each image that includes text using a saliency map generated in step 1606. For example, step 1608 may include identifying one or more rectangles that indicate the position of text in the image. In some implementations, step 1608 includes determining a portion of the image to keep based on the areas of the image that contain salient objects and the areas of the image that contain text. For example, step 1608 may include discarding the portions of the image that contain text while keeping the portions of the image that contain salient objects. Step 1608 may include cropping text from the image by generating a rectangle that includes one or more rectangles containing salient objects and none of the rectangles containing text. In some implementations, step 1608 includes cropping an image to include only the image content within the rectangle generated in step 1608 (e.g., salient objects, faces, etc.).

In some implementations, step 1608 includes cropping a logo image from an image sprite. For example, some of the images extracted in step 1604 may be a combination or compilation of individual button or logo images (e.g., a stitched canvas containing multiple logos in a grid). Step 1608 may include determining the location of a logo image within the image sprite and cropping the image sprite such that only the logo image remains.

In some implementations, step 1608 includes enhancing or optimizing the images extracted in step 1604 for use in the generated content item. Enhancing or optimizing an image may include, for example, rounding the edges of the image, adding lighting effects to the image, adding texture or depth to the image, and/or applying other effects to enhance the visual impact of the image.

In some implementations, step 1608 includes the content detection results produced in step 1606 to identify logo images. Some logo images may be extracted in step 1604 as flat and simple logos. For example, the landing resource may rely on CSS or another content markup scheme to change the appearance of a flat/simple logo when the logo is rendered by user devices 108. Step 1608 may include processing logo images to convert a flat/simple logo into an optimized logo by causing the logos to appear three-dimensional, adding depth or lighting effects, rounding corners, causing the logos to appear as buttons, optimizing the logos for display on mobile devices, or otherwise adjusting the logos to improve the visual impact thereof. Step 1608 may include storing the processed images in a data storage device.

Still referring to FIG. 16, process 1600 is shown to include scoring the image based on at least one of the detected visual content and the detected semantic content (step 1610). In some implementations, step 1610 is performed by image ranking module 308 as described with reference to FIG. 3. Step 1610 may include ranking the various images to determine which of the images to include in the generated content item.

In some implementations, step 1610 includes assigning a salience score to each of the images extracted from the landing resource in step 1604. The salience score for an image may indicate the relative importance or prominence with which the image is displayed on the landing resource. For example, the salience score for an image may depend on the vertical placement of the image (e.g., top of the page, middle of the page, bottom of the page, etc.), the display size of the image (e.g., display height, display width, etc.), whether the image is centered on the landing resource, and/or other image salience scoring criteria.

One example of an image salience scoring algorithm that can be used to assign a salience score in step 1610 is:

Salience=α*sigmoid₁(position_{y},y₀,dy)+β*sigmoid₂(width,w₀,d_{size})*sigmoid₂(height,h₀,d_{size})+δ*central_alignment

In some implementations, α, β, and δ are all positive and sum to 1.0.
Sigmoid₁(position_{y},y₀,dy) may be a sigmoid function ranging from 1.0 at position_{y}=0 (e.g., the top of landing resource 106) to 0.0 at position_{y}=∞ (e.g., the bottom of the landing resource, significantly distant from the top of the landing resource, etc.). y₀ may be the point at which Sigmoid₁=0.5 and dy may control the slope of the sigmoid function around y₀. Sigmoid₂ may be defined as (1−Sigmoid₁) and central_alignment may be a measure of whether the image is centrally aligned (e.g., horizontally centered) on the landing resource. Central_alignment may be 1.0 if the image is perfectly centered and may decrease based on the distance between the center of the image and the horizontal center of the landing resource.

Step 1610 may include ranking the images extracted in step 1604. In some implementations, the rankings are based on the salience scores assigned to each image. Salience scores may indicate the content requestor's preference for the images and may be a valuable metric in determining which images are most likely to be approved by the content requestor. Salience scores may also indicate how well the images correspond to the content featured on the landing resource.

In some implementations, step 1610 includes ranking the images based on various relevancy criteria associated with the images. For example, step 1610 may include using relevancy criteria to assign each image a relevancy score. Step 1610 may include determining a relevancy score for an image by comparing the image (e.g., image metadata, image content, etc.) with a list of keywords based on the URL of the landing resource or the automatically-generated content item. For example, the list of keywords may be based on a business classification, business type, business category, or other attributes of the business or entity associated with the landing resource. In some implementations, the list of keywords may be based on the title of the generated content item or other attributes of the content item (e.g., campaign, ad group, featured product, etc.). The relevancy score may indicate the likelihood that a particular image represents the business, product, or service featured in the automatically-generated content item.

In some implementations, step 1610 includes performing one or more threshold tests prior to ranking the images. For example, step 1610 may include comparing the quality score assigned to each image in step 1606 with a threshold quality score. If the quality score for an image is less than the threshold quality score, step 1610 may include discarding the image. Step 1610 may include comparing the display size of each of the extracted and processed images to a threshold display size. If the display size for an image is less than the threshold display size, step 1610 may include discarding the image.

In some implementations, image content step 1610 includes generating multiple lists of images. One list generated in step 1610 may be a list of logo images. Another list generated in step 1610 may be a list of product and/or prominent images extracted from the landing resource. Another list generated in step 1610 may be a list of images that have previously been used and/or approved by the content requestor (e.g., images extracted from the used images database). The lists of images may include attributes associated with each image such as image width, image height, salience score, relevance score, or other image information. Step 1610 may include arranging the images in the lists according to the saliency scores and/or relevancy scores assigned to the images.

Still referring to FIG. 16, process 1600 is shown to include selecting a highest-scoring image from a set of images including the image extracted from the landing resource (step 1612). The set of images may include one or more images extracted from the landing resource and one or more images extracted from other data sources (e.g., used images database 310, stock images database 312, etc.). The highest-scoring image may be the image with the highest saliency score that satisfies all of the threshold criteria (e.g., display size criteria, quality score criteria, etc.).

In some implementations, step 1612 includes selecting an image that is most relevant to a particular content item, search query, landing resource, or user device. Step 1612 may include identifying keywords associated with the content item in which the selected image will be included. For example, step 1612 may include identifying a headline, title, topic, or other attribute of the content item. Step 1612 may include determining one or more keywords associated with related content items (e.g., content items in the same ad group, part of the same campaign, associated with the same content provider, etc.). Keywords for the landing resource and/or search query may be extracted from the content of the landing resource and the search query, respectively. Keywords for a particular user device may be based on a user interests profile, recent browsing history, history of search queries, geographic limiters, or other attributes of the user device. Step 1612 may include comparing keywords associated with each of the images with the keywords associated with the landing resource, search query, or user device. Step 1612 may include determining which of the images is most relevant based on the keywords comparison and selecting the most relevant image for use in the generated content item.

Still referring to FIG. 16, process 1600 is shown to include generating a third-party content item that includes the selected image (step 1614) and serving the third-party content item to a user device (step 1616). Generating a third-party content item that includes the selected image may include combining the selected image with a text snippet, font family, color scheme, and/or layout previously extracted from the landing resource and selected (e.g., by performing one or more steps of processes 1300-1500) for use in the generated content item. Serving the content item to a user device may include delivering the content item to the user device or to a first-party resource. The user device may render and display the third-party content item in conjunction with first-party resource content.

The third-party content item may be configured to direct the user device to the landing resource upon an interaction with the third-party content item by the user device. An interaction with a content item may include displaying the content item, hovering over the content item, clicking on the content item, viewing source information for the content item, or any other type of interaction between user devices and a content item. Interaction with a content item does not require explicit action by a user with respect to a particular content item. In some implementations, an impression (e.g., displaying or presenting the content item) may qualify as an interaction. The criteria for defining which user actions (e.g., active or passive) qualify as an interaction may be determined on an individual basis (e.g., for each content item) by the content requestor or by content generation system 114.

Still referring to FIG. 16, process 1600 is shown to include collecting serving statistics and monitoring the landing resource for changes to determine whether to update the third-party content item (step 1618). Collecting serving statistics may include determining number of times the generated content item is served to a user device, the number of times the generated content item is viewed or clicked by the user device, and/or detecting other interactions between the generated content item and the user device. In some implementations, step 1618 includes evaluating performance statistics associated with the generated content item (e.g., predicted click-through-rate, actual click-through-rate, number of conversions, profitability, etc.). The performance statistics may indicate whether the generated content item is effective and therefore should be reused, or whether the generated content item is ineffective and therefore should be replaced (i.e., updated) with new content items.

Monitoring the landing resource for changes may include comparing a version of the landing resource at the time that the images were extracted with a current version of the landing resource. If the landing resource has changed since the time the images were extracted (e.g., new or different images, new of different content, etc.), step 1618 may include determining that the generated content items should be updated to reflect the changed content of the landing resource. If it is determined in step 1618 that the generated content items should be updated, process 1600 can be repeated (e.g., starting with step 1604) to extract new images from the landing resource, analyze, process, and rank the newly extracted images, and generate new content items using the newly extracted images.

Implementations of the subject matter and the operations described in this specification may be implemented in digital electronic circuitry, or in computer software, firmware, or hardware, including the structures disclosed in this specification and their structural equivalents, or in combinations of one or more of them. Implementations of the subject matter described in this specification may be implemented as one or more computer programs, i.e., one or more modules of computer program instructions, encoded on one or more computer storage medium for execution by, or to control the operation of, data processing apparatus. Alternatively or in addition, the program instructions may be encoded on an artificially-generated propagated signal (e.g., a machine-generated electrical, optical, or electromagnetic signal) that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate components or media (e.g., multiple CDs, disks, or other storage devices). Accordingly, the computer storage medium is both tangible and non-transitory.

The operations described in this disclosure may be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application-specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive), etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD-ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user and a keyboard, a pointing device, e.g., a mouse, trackball, etc., or a touch screen, touch pad, etc.) by which the user may provide input to the computer. Other kinds of devices may be used to provide for interaction with a user as well; for example, feedback provided to the user may be any form of sensory feedback (e.g., visual feedback, auditory feedback, or tactile feedback), and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Implementations of the subject matter described in this disclosure may be implemented in a computing system that includes a back-end component (e.g., as a data server), or that includes a middleware component (e.g., an application server), or that includes a front-end component (e.g., a client computer) having a graphical user interface or a web browser through which a user may interact with an implementation of the subject matter described in this disclosure, or any combination of one or more such back-end, middleware, or front-end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

While this specification contains many specific implementation details, these should not be construed as limitations on the scope of any disclosures or of what may be claimed, but rather as descriptions of features specific to particular implementations of particular disclosures. Certain features that are described in this disclosure in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products embodied on one or more tangible media.

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

Thus, particular implementations of the subject matter have been described. Other implementations are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computerized method for automatically generating display content, the method comprising:
receiving, at a processing circuit, a uniform resource locator from a third-party content provider, the uniform resource locator identifying a landing resource;
extracting, by the processing circuit, an image from the landing resource;
analyzing, by the processing circuit, the extracted image to detect visual content of the image and semantic content of the image;
scoring, by the processing circuit, the image based on at least one of the detected visual content and the detected semantic content;
selecting, by the processing circuit, a highest-scoring image from a set of images comprising the image extracted from the landing resource; and
generating, by the processing circuit, a third-party content item that includes the selected image, wherein the third-party content item is configured to direct to the landing resource.

2. The method of claim 1, further comprising:
determining whether processing is required for the image based on a result of the analysis; and
processing the image to enhance at least one of the detected visual content of the image and the detected semantic content of the image in response to a determination that processing is required.

3. The method of claim 1, wherein extracting the image from the landing resource comprises:
determining a salience score for the image, the salience score indicating a prominence with which the extracted image is displayed on the landing resource.

4. The method of claim 1, further comprising:
collecting a plurality of images from multiple different locations including at least one of the landing resource, a resource under a same domain or sub-domain as the landing resource, and a repository of images previously used in content items associated with the third-party content provider.

5. The method of claim 1, wherein analyzing the extracted image to detect visual content comprises determining a position of a salient object in the image.

6. The method of claim 5, wherein determining a position of a salient object in the image comprises at least one of detecting a color distribution of the image and detecting an edge of the salient object in the image.

7. The method of claim 1, wherein analyzing the extracted image to detect visual content comprises determining a position of text in the image.

8. The method of claim 1, wherein analyzing the extracted image to detect visual content comprises:
generating a salience map for the image, the salience map identifying a position of a salient object in the image and a position of any text in the image.

9. The method of claim 1, wherein analyzing the extracted image to detect semantic content comprises:
generating one or more labels describing the semantic content of the image; and
storing the generated labels as attributes of the image.

10. The method of claim 1, wherein analyzing the extracted image to detect visual content comprises determining whether to crop the image based on a location of a salient object represented in the image; and
wherein processing the image comprises cropping the image to enhance a visual impact of the salient object in response to a determination to crop the image.

11. The method of claim 1, further comprising:
identifying one or more aesthetic features of the image;
applying the one or more aesthetic features as inputs to an algorithmic ranking process trained on human-labeled image preferences, wherein the algorithmic ranking process is configured to use the aesthetic features to generate a quality score for the image based on the human-labeled image preferences.

12. A system for automatically generating display content, the system comprising:
a processing circuit configured to:
receive a uniform resource locator from a third-party content provider, the uniform resource locator identifying a landing resource;
extract an image from the landing resource;
analyze the extracted image to detect visual content of the image and semantic content of the image;
score the image based on at least one of the detected visual content and the detected semantic content;
select a highest-scoring image from a set of images comprising the image extracted from the landing resource; and
generate a third-party content item that includes the selected image, wherein the third-party content item is configured to direct to the landing resource.

13. The system of claim 12, wherein the processing circuit is configured to:
determine whether processing is required for the image based on a result of the analysis; and
process the image to enhance at least one of the detected visual content of the image and the detected semantic content of the image in response to a determination that processing is required.

14. The system of claim 12, wherein extracting the image from the landing resource comprises:
determining a salience score for the image, the salience score indicating a prominence with which the extracted image is displayed on the landing resource.

15. The system of claim 12, wherein the processing circuit is configured to:
collect a plurality of images from multiple different locations including at least one of the landing resource, a resource under a same domain or sub-domain as the landing resource, and a repository of images previously used in content items associated with the third-party content provider.

16. The system of claim 12, wherein analyzing the extracted image to detect visual content comprises:
determining a position of at least one of: a salient object in the image and text in the image; and
generating a salience map for the image, the salience map identifying the position of at least one of: the salient object in the image and the text in the image.

17. The system of claim 12, wherein analyzing the extracted image to detect semantic content comprises:
generating one or more labels describing the semantic content of the image; and
storing the generated labels as attributes of the image.

18. The system of claim 12, wherein analyzing the extracted image to detect visual content comprises determining whether to crop the image based on a location of a salient object represented in the image; and
wherein processing the image comprises cropping the image to enhance a visual impact of the salient object in response to a determination to crop the image.

19. A system for extracting and generating images for display content, the system comprising:
a processing circuit configured to extract images from a plurality of data sources comprising a landing resource and at least one other data source;
wherein the processing circuit is configured to detect a distribution of content in each of the extracted images, the distribution of content comprising at least one of a location of a salient object and a location of text;
wherein the processing circuit is configured to process the extracted images based on a result of the content distribution detection, wherein processing an extracted image comprises cropping the extracted image in response to a determination that the salient object detected in the image occupies less than a threshold area in the image; and
wherein the processing circuit is configured to rank the extracted images based at least partially on a result of the content distribution detection.

20. The system of claim 19, wherein the processing circuit is configured to calculate an on-page salience score for each of the images extracted from the landing resource, the salience score indicating a prominence with which the extracted image is displayed on the landing resource;
wherein ranking the extracted images is based at least partially on the on-page salience scores for each of the images extracted from the landing resource.
